(19) United States
(12) Patent Application Publication
(10) Pub. No.: US 2026/0270664 A1
(43) Pub. Date: Sep. 10, 2026

(54) COMMUNICATION METHOD FOR SENSING AND COMMUNICATION APPARATUS

(71) Applicant: HUAWEI TECHNOLOGIES CO., LTD., Shenzhen (CN)

(72) Inventors: Junfan Wang, Shanghai (CN); Xueqiang Yan, Shanghai (CN); Yan Xi, Shanghai (CN); Mingyu Zhao, Shanghai (CN); Wenxuan Ye, Munich (DE)

(73) Assignee: HUAWEI TECHNOLOGIES CO., LTD., Shenzhen (CN)

(21) Appl. No.: 19/662,886

(22) Filed: Apr. 29, 2026

Related U.S. Application Data
(63) Continuation of application No. PCT/CN2024/127773, filed on Oct. 28, 2024.

(30) Foreign Application Priority Data
Oct. 30, 2023 (CN) 202311426503.0

(51) Int. Cl. H04W 4/38; H04W 4/50; H04W 64/00

(52) U.S. Cl. CPC H04W 4/38; H04W 4/50; H04W 64/00

(57) ABSTRACT

This application provides a communication method for sensing and a communication apparatus. One example method includes: receiving first configuration information, where the first configuration information includes a first threshold, the first threshold indicates a sensing range of a first sensing entity for a service requirement of a first sensing service, the first threshold is determined based on the service requirement of the first sensing service, and the first sensing service is implemented based on sensing on a first sensing target by the first sensing entity; and determining, based on the first configuration information and position information of the first sensing target, another sensing entity to execute the first sensing service.

### CROSS-REFERENCE TO RELATED APPLICATIONS

This application is a continuation of International Application No. PCT/CN2024/127773, filed on Oct. 28, 2024, which claims priority to Chinese Patent Application No. 202311426503.0, filed on Oct. 30, 2023. The disclosures of the aforementioned applications are hereby incorporated by reference in their entireties.

### TECHNICAL FIELD

This application relates to the field of communication technologies, and more specifically, to a communication method for sensing and a communication apparatus.

### BACKGROUND

During the evolution of the 5th generation (5G) mobile communication system toward 5G-advanced (5G-A), integrated sensing and communication is considered as one of key technologies for extending service capabilities of mobile communication networks. This technology aims to integrate wireless communication and sensing functions into a same system, exploiting various propagation characteristics of radio signals to enable target detecting and imaging. In this way, communication and sensing capabilities are integrated into one network, thereby achieving harmonious coexistence and even mutual benefits.

In sensing scenarios, a plurality of sensing entities may be involved. These entities may collect data within their respective sensing service coverage, and collaboratively accomplish sensing services. Considering that sensing targets may be mobile, when a sensing target moves, the sensing target may move out of a sensing service range of a current sensing entity and enter a zone that cannot be sensed, resulting in the inability to perform sensing services continuously.

Therefore, there is an urgent need for a communication method for sensing, to ensure continuity of wireless sensing services when the sensing target moves.

### SUMMARY

This application provides a communication method for sensing and a communication apparatus, to ensure continuity of a wireless sensing service when a sensing target moves.

According to a first aspect, a communication method for sensing is provided. The method may be performed by a first sensing entity or a first network device, or may be performed by a chip or a circuit configured in the first sensing entity or the first network device, or may be performed by a logical module or software that can implement all or a part of functions of the first sensing entity or the first network device. This is not limited in this application.

The method includes: receiving first configuration information, where the first configuration information includes a first threshold, the first threshold indicates a sensing range of the first sensing entity for a first sensing service, the first threshold is determined based on a service requirement of the first sensing service, and the first sensing service is implemented based on sensing on a first sensing target by the first sensing entity; and determining, based on the first configuration information and position information of the first sensing target, another sensing entity to execute the first sensing service.

In this application, the method may be applied to the first sensing entity or the first network device.

The first sensing entity is an access network device or a terminal device having a sensing function. This is not limited in this application.

The first network device is a network entity having a sensing data processing function, for example, an SDPF.

In a sensing scenario, when a sensing target moves within a maximum sensing service range of a sensing entity, the sensing entity may determine valid sensing data based on a sensing signal. However, for sensing requirements of different sensing services, even if the sensing target moves within the maximum sensing service range, continuity of a sensing service of the sensing target may not be ensured, and a fault like interruption of the current sensing service may occur. In this application, a sensing range based on a service requirement of a sensing service is proposed to determine another sensing entity to execute the current sensing service. When the sensing target moves within the sensing range based on the service requirement of the sensing service, service stability can be ensured. The another sensing entity may be determined, based on the sensing range, to execute the current sensing service, thereby ensuring continuity of the sensing service. In other words, the sensing entity not only needs to meet a maximum sensing service range, but also needs to meet a sensing range for a service requirement of the current sensing service. In this way, it is ensured that valid sensing data of the sensing service is continuously uploaded, a requirement of the sensing service is met, and a sensing capability is improved.

With reference to the first aspect, in some implementations of the first aspect, determining, based on the first configuration information and the position information of the first sensing target, the another sensing entity to execute the first sensing service includes: determining a first distance, where the first distance is a distance between the first sensing target and the first sensing entity; and when the first distance is greater than or equal to the first threshold, determining the another sensing entity to execute the first sensing service.

In this technical solution, when it is determined that a current position of the first sensing target has exceeded a sensing range for a sensing requirement of the first sensing service, the another sensing entity may be determined to execute the first sensing service. In other words, when the first sensing target moves out of the sensing range of the first sensing entity for the service requirement of the first sensing service, the first sensing service may be interrupted. In this case, the another sensing entity needs to be determined to execute the first sensing service, to ensure continuity of the first sensing service.

With reference to the first aspect, in some implementations of the first aspect, first request information is generated based on the first configuration information, where the first request information is used to request a second sensing entity to execute the first sensing service; and the first request information is sent to the second sensing entity.

In this technical solution, either the first sensing entity or the first network device may determine another sensing entity (the second sensing entity) based on the first configuration information, and may request, based on the first request information, the second sensing entity to execute the first sensing service.

With reference to the first aspect, in some implementations of the first aspect, the first request information includes indication information of the first sensing service, indication information of the first sensing entity, indication information of the second sensing entity, and sensing information.

In this application, the indication information of the first sensing service may be, for example, an identifier or a name of the first sensing service, or may be other information indicating the first sensing service. This is not limited in this application. The indication information of the first sensing entity may be, for example, an identifier or a name of the first sensing entity, or may be other information indicating the first sensing entity. This is not limited in this application. The indication information of the second sensing entity may be, for example, an identifier or a name of the second sensing entity, or may be other information indicating the second sensing entity. This is not limited in this application. Details are not described again below.

In this application, the sensing information may include position information, point cloud information, and the like of the first sensing target.

With reference to the first aspect, in some implementations of the first aspect, when the method is applied to the first sensing entity, the first configuration information further includes indication information of a sensing entity and a first determining mode, the indication information of the sensing entity includes the indication information of the first sensing entity and indication information of a sensing entity adjacent to the first sensing entity, and the first determining mode indicates the first sensing entity to determine the second sensing entity.

It may be understood that the first determining mode indicates the first sensing entity to determine another sensing entity to execute the first sensing service, and the first sensing entity may determine the another sensing entity based on sensing capability information and position information of an adjacent sensing entity.

With reference to the first aspect, in some implementations of the first aspect, the first configuration information may further include maximum effective sensing distances of the second sensing entity and another adjacent sensing entity and position information of the second sensing entity and the another adjacent sensing entity.

With reference to the first aspect, in some implementations of the first aspect, the first sensing entity receives second request information from the second sensing entity or the first network device; and stops executing the first sensing service based on the second request information.

In this application, the first sensing target is in a moving state. When the first sensing target has entered a sensing range of the second sensing entity for the service requirement of the first sensing service, the first sensing entity may stop sensing. In this case, the first sensing entity may determine, based on the second sensing entity or the first network device, that the first sensing target has entered the sensing range of the second sensing entity for the service requirement of the first sensing service, to stop executing the first sensing service. This solution can not only ensure continuity of a sensing service, but also save power of the first sensing entity.

With reference to the first aspect, in some implementations of the first aspect, when the method is applied to the first network device, the first configuration information further includes indication information of a sensing entity and a second determining mode, the indication information of the sensing entity includes the indication information of the first sensing entity and indication information of a sensing entity adjacent to the first sensing entity, and the second determining mode indicates the first network device to determine the second sensing entity.

It may be understood that the second determining mode indicates the first sensing entity to determine another sensing entity to execute the first sensing service, and the first network device may determine the another sensing entity based on sensing capability information and position information of a sensing entity adjacent to the first sensing entity.

With reference to the first aspect, in some implementations of the first aspect, the first configuration information may further include maximum effective sensing distances of the first sensing entity, the second sensing entity, and another adjacent sensing entity and position information of the second sensing entity and the another adjacent sensing entity.

With reference to the first aspect, in some implementations of the first aspect, the first network device sends second request information to the first sensing entity, where the second request information is used to request to stop executing the first sensing service.

With reference to the first aspect, in some implementations of the first aspect, the first configuration information further includes a second threshold, and the second threshold indicates a sensing range of the second sensing entity for the service requirement of the first sensing service.

With reference to the first aspect, in some implementations of the first aspect, the first network device or the second sensing device determines a second distance, where the second distance is a distance between the first sensing target and the second sensing entity; and when the second distance is less than or equal to the second threshold, the first network device or the second sensing device sends the second request information to the first sensing entity.

In this solution, the second sensing entity may determine that the first sensing target has entered the sensing range of the second sensing entity for the service requirement of the first sensing service, or the first network device may determine, based on sensing data, that the first sensing target has entered the sensing range of the second sensing entity for the service requirement of the first sensing service, so that the second sensing entity may be indicated to stop sensing.

With reference to the first aspect, in some implementations of the first aspect, third request information is generated based on the first configuration information, where the third request information is used to request a second network device to determine the second sensing entity; and the third request information is sent to the second network device.

The second network device is a network entity having a sensing service control function, for example, an SSCF.

In this application, when determining another sensing entity, the first sensing entity or the first network device may further request the second network device to determine the second sensing entity.

It may be understood that the second network device has a control function, and the second network device obtains sensing capability information and position information of the first sensing entity and the adjacent sensing entity in a registration phase. Therefore, the second network device may determine a proper sensing entity based on a sensing range of each sensing entity for the service requirement of the first sensing service.

For example, the second network device may obtain the maximum effective sensing distances of the second sensing entity and the another adjacent sensing entity and the position information of the second sensing entity and the another adjacent sensing entity.

With reference to the first aspect, in some implementations of the first aspect, the third request information includes indication information of the first sensing service, indication information of the first sensing entity, and sensing information.

With reference to the first aspect, in some implementations of the first aspect, the first configuration information further includes the indication information of the first sensing service and a third determining mode, and the third determining mode indicates the second network device to determine the second sensing entity.

It may be understood that the third determining mode indicates the second network device to determine another sensing entity to execute the first sensing service, and the second network device may determine the another sensing entity based on sensing capability information and position information of a sensing entity adjacent to the first sensing entity.

With reference to the first aspect, in some implementations of the first aspect, the first sensing entity receives sixth request information from the second network device; and stops executing the first sensing service based on the sixth request information.

In this application, the first sensing target is in a moving state. When the first sensing target has entered a sensing range of the second sensing entity for the service requirement of the first sensing service, the first sensing entity may stop sensing. In this case, the first sensing entity may determine, based on the second network device, that the first sensing target has entered the sensing range of the second sensing entity for the service requirement of the first sensing service, to stop executing the first sensing service. This solution can not only ensure continuity of a sensing service, but also save power of the first sensing entity.

With reference to the first aspect, in some implementations of the first aspect, the first sensing entity and the second sensing entity are access network devices or terminal devices, the first network device is a sensing data processing function, and the second network device is a sensing service control function.

According to a second aspect, a communication method for sensing is provided. The method may be performed by a second network device, or may be performed by a chip or a circuit configured in the second network device, or may be performed by a logical module or software that can implement all or a part of functions of the second network device. This is not limited in this application.

The method includes: receiving third request information, where the third request information is determined by a first sensing entity based on first configuration information, the first configuration information includes a first threshold, the first threshold indicates a sensing range of the first sensing entity for a service requirement of a first sensing service, the first threshold is determined based on the service requirement of the first sensing service, and the first sensing service is implemented based on sensing on a first sensing target by the first sensing entity; and determining, based on the third request information, a second sensing entity to execute the first sensing service.

In this application, the method may be applied to the second network device.

The second network device is a network entity having a sensing service control function, for example, an SSCF.

In this technical solution, the second network device may receive the third request information from the first sensing entity and the first network device, to determine the second sensing entity to execute the first sensing service. The third request information is determined based on a sensing range for a service requirement of a first sensing service. In other words, the first sensing entity may not meet a sensing range for a service requirement of a current sensing service, and the second network device determines the second sensing entity to execute the first sensing service, to ensure that valid sensing data of the sensing service is continuously uploaded, a requirement of the sensing service is met, and a sensing capability is improved.

With reference to the second aspect, in some implementations of the second aspect, the third request information includes indication information of the first sensing service, indication information of the first sensing entity, and sensing information.

In this application, the indication information of the first sensing service may be, for example, an identifier or a name of the first sensing service, or may be other information indicating the first sensing service. This is not limited in this application. The indication information of the first sensing entity may be, for example, an identifier or a name of the first sensing entity, or may be other information indicating the first sensing entity. This is not limited in this application. Details are not described again below.

In this application, the sensing information may include position information, point cloud information, and the like of the first sensing target.

With reference to the second aspect, in some implementations of the second aspect, fourth request information is sent to the second sensing entity, where the fourth request information includes the indication information of the first sensing service, the indication information of the first sensing entity, indication information of the second sensing entity, and the sensing information.

In this application, the indication information of the second sensing entity may be, for example, an identifier or a name of the second sensing entity, or may be other information indicating the second sensing entity. This is not limited in this application.

With reference to the second aspect, in some implementations of the second aspect, before receiving the third request information, the method further includes: sending the first configuration information to the first sensing entity and/or the first network device.

In this technical solution, the second network device determines, based on a requirement of the first sensing service, a sensing range corresponding to each sensing entity, and indicates, based on the first configuration information, the sensing range to the first sensing device and/or the first network device.

With reference to the second aspect, in some implementations of the second aspect, the first configuration information further includes indication information of a sensing entity and a third determining mode, the indication information of the sensing entity includes the indication information of the first sensing entity and indication information of a sensing entity adjacent to the first sensing entity, and the third determining mode indicates the second network device to determine the second sensing entity.

It may be understood that the third determining mode indicates the second network device to determine another sensing entity to execute the first sensing service, and the second network device may determine the another sensing entity based on sensing capability information and position information of a sensing entity adjacent to the first sensing entity.

With reference to the second aspect, in some implementations of the second aspect, fifth request information sent from the second sensing entity is received; and sixth request information is sent to the first sensing entity based on the fifth request information, where the fifth request information is used to request the first sensing entity to stop executing the first sensing service.

In this technical solution, the second sensing entity determines that the current first sensing target has entered a sensing range of the second sensing entity for the service requirement of the first sensing service, to indicate to stop executing the first sensing service through the second network device. This solution can not only ensure continuity of the sensing service, but also save power of the first sensing entity.

With reference to the second aspect, in some implementations of the second aspect, the first sensing entity and the second sensing entity are access network devices or terminal devices, the first network device is a sensing data processing function, and the second network device is a sensing service control function.

According to a third aspect, a communication apparatus is provided. The apparatus may be a first sensing entity or a first network device, or may be a chip or a circuit configured in the first sensing entity or the first network device, or may be a logical module or software that can implement all or a part of functions of the first sensing entity or the first network device. This is not limited in this application.

The apparatus includes: a transceiver unit, configured to receive first configuration information, where the first configuration information includes a first threshold, the first threshold indicates a sensing range of a first sensing entity for a service requirement of a first sensing service, the first threshold is determined based on the service requirement of the first sensing service, and the first sensing service is implemented based on sensing on a first sensing target by the first sensing entity; and a processing unit, configured to determine, based on the first configuration information and position information of the first sensing target, another sensing entity to execute the first sensing service.

With reference to the third aspect, in some implementations of the third aspect, the processing unit is further configured to determine a first distance, where the first distance is a distance between the first sensing target and the first sensing entity; and the processing unit is further configured to determine, when the first distance is greater than or equal to the first threshold, another sensing entity to execute the first sensing service.

With reference to the third aspect, in some implementations of the third aspect, the processing unit is further configured to generate first request information based on the first configuration information, where the first request information is used to request a second sensing entity to execute the first sensing service; and the transceiver unit is further configured to send the first request information to the second sensing entity.

With reference to the third aspect, in some implementations of the third aspect, the first request information includes indication information of the first sensing service, indication information of the first sensing entity, indication information of the second sensing entity, and sensing information.

With reference to the third aspect, in some implementations of the third aspect, when the apparatus is the first sensing entity, the first configuration information further includes indication information of a sensing entity and a first determining mode, the indication information of the sensing entity includes the indication information of the first sensing entity and indication information of a sensing entity adjacent to the first sensing entity, and the first determining mode indicates the first sensing entity to determine the second sensing entity.

With reference to the third aspect, in some implementations of the third aspect, the first configuration information may further include maximum effective sensing distances of the second sensing entity and another adjacent sensing entity and position information of the second sensing entity and the another adjacent sensing entity.

With reference to the third aspect, in some implementations of the third aspect, the transceiver unit is further configured to receive second request information from the second sensing entity or the first network device; and the processing unit is further configured to stop executing the first sensing service based on the second request information.

With reference to the third aspect, in some implementations of the third aspect, when the apparatus is the first network device, the first configuration information further includes indication information of a sensing entity and a second determining mode, the indication information of the sensing entity includes the indication information of the first sensing entity and indication information of a sensing entity adjacent to the first sensing entity, and the second determining mode indicates the first network device to determine the second sensing entity.

With reference to the third aspect, in some implementations of the third aspect, the first configuration information may further include maximum effective sensing distances of the second sensing entity and another adjacent sensing entity and position information of the second sensing entity and the another adjacent sensing entity.

With reference to the third aspect, in some implementations of the third aspect, the transceiver unit is further configured to send second request information, where the second request information is used to request to stop executing the first sensing service.

With reference to the third aspect, in some implementations of the third aspect, the first configuration information further includes a second threshold, and the second threshold indicates a sensing range of the second sensing entity for the service requirement of the first sensing service.

With reference to the third aspect, in some implementations of the third aspect, the processing unit is further configured to determine a second distance, where the second distance is a distance between the first sensing target and the second sensing entity; and when the second distance is less than or equal to the second threshold, the transceiver unit is further configured to send the second request information to the first sensing entity.

With reference to the third aspect, in some implementations of the third aspect, the processing unit is further configured to: generate third request information based on the first configuration information, where the third request information is used to request a second network device to determine the second sensing entity; and send the third request information to the second network device.

With reference to the third aspect, in some implementations of the third aspect, the third request information includes indication information of the first sensing service, indication information of the first sensing entity, and sensing information.

With reference to the third aspect, in some implementations of the third aspect, the first configuration information further includes the indication information of the first sensing service and a third determining mode, and the third determining mode indicates the second network device to determine the second sensing entity.

With reference to the third aspect, in some implementations of the third aspect, the transceiver unit is further configured to receive sixth request information from the second network device; and the processing unit is further configured to stop executing the first sensing service based on the sixth request information.

With reference to the third aspect, in some implementations of the third aspect, the first sensing entity and the second sensing entity are access network devices or terminal devices, the first network device is a sensing data processing function, and the second network device is a sensing service control function.

It should be understood that a specific process and a possible implementation in which the transceiver unit and the processing unit of the apparatus perform corresponding steps are described in detail in the first aspect. For beneficial effects of this aspect, refer to the first aspect. For brevity, details are not described herein again.

According to a fourth aspect, a communication apparatus is provided. The apparatus may be a second network device, or may be a chip or a circuit configured in the second network device, or may be a logical module or software that can implement all or a part of functions of the second network device. This is not limited in this application.

The apparatus includes: a transceiver unit, configured to receive third request information, where the third request information is determined by a first sensing entity based on first configuration information, the first configuration information includes a first threshold, the first threshold indicates a sensing range of the first sensing entity for a service requirement of a first sensing service, the first threshold is determined based on the service requirement of the first sensing service, and the first sensing service is implemented based on sensing on a first sensing target by the first sensing entity; and the processing unit is configured to determine, based on the third request information, the second sensing entity to execute the first sensing service.

With reference to the fourth aspect, in some implementations of the fourth aspect, the third request information includes indication information of the first sensing service, indication information of the first sensing entity, and sensing information.

In this application, the sensing information may include position information, point cloud information, and the like of the first sensing target.

With reference to the fourth aspect, in some implementations of the fourth aspect, the transceiver unit is further configured to send fourth request information to the second sensing entity, where the fourth request information includes the indication information of the first sensing service, the indication information of the first sensing entity, indication information of the second sensing entity, and the sensing information.

With reference to the fourth aspect, in some implementations of the fourth aspect, the transceiver unit is further configured to send the first configuration information to the first sensing entity and/or the first network device.

With reference to the fourth aspect, in some implementations of the fourth aspect, the first configuration information further includes the indication information of the first sensing service and a third determining mode, and the third determining mode indicates the second network device to determine the second sensing entity.

With reference to the fourth aspect, in some implementations of the fourth aspect, the transceiver unit is further configured to receive fifth request information sent from the second sensing entity; and the transceiver unit is further configured to send sixth request information to the first sensing entity based on the fifth request information, where the fifth request information is used to request the first sensing entity to stop executing the first sensing service.

With reference to the fourth aspect, in some implementations of the fourth aspect, the first sensing entity and the second sensing entity are access network devices or terminal devices, the first network device is a sensing data processing function, and the second network device is a sensing service control function.

It should be understood that a specific process and a possible implementation in which the transceiver unit and the processing unit of the apparatus perform corresponding steps are described in detail in the second aspect. For beneficial effects of this aspect, refer to the second aspect. For brevity, details are not described herein again.

According to a fifth aspect, this application provides a communication apparatus, including a processor, configured to perform the method provided in the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this application.

Optionally, the communication apparatus further includes a memory, configured to store a program. The processor is configured to execute a computer program or instructions stored in the memory, to perform the method provided in any one of the foregoing aspects or the implementations of the foregoing aspects.

According to a sixth aspect, this application provides a communication system. The system includes a first sensing entity, a first network device, and a second network device. The second network device is configured to send first configuration information to the first sensing entity or the first network device. The first configuration information includes a first threshold, the first threshold indicates a sensing range of the first sensing entity for a first sensing service, the first threshold is determined based on a service requirement of the first sensing service, and the first sensing service is implemented based on sensing on a first sensing target by the first sensing entity. The first sensing entity or the first network device is configured to receive the first configuration information. The first sensing entity or the first network device is further configured to determine, based on the first configuration information and position information of the first sensing target, another sensing entity to execute the first sensing service.

According to a seventh aspect, this application provides a communication system. The system includes the communication apparatus according to the third aspect and the communication apparatus according to the fourth aspect.

According to an eighth aspect, this application provides a computer-readable storage medium. The computer-readable storage medium stores a computer program or instructions. When the computer program or the instructions are run on a computer, the method provided in any one of the foregoing aspects or the implementations of the foregoing aspects is performed.

According to a ninth aspect, this application provides a computer program product including instructions. When the computer program product runs on a computer, the method provided in any one of the foregoing aspects or the implementations of the foregoing aspects is performed.

According to a tenth aspect, this application provides a chip. The chip includes a processor and a communication interface. The processor reads, through the communication interface, instructions stored in a memory, to perform the method provided in any one of the foregoing aspects or the implementations of the foregoing aspects.

Optionally, in an implementation, the chip further includes the memory. The memory stores a computer program or the instructions. The processor is configured to execute the computer program or the instructions stored in the memory. When the computer program or the instructions are executed, the processor is configured to perform the method provided in any one of the foregoing aspects or the implementations of the foregoing aspects.

The chip may include an input circuit or interface configured to send information or data, and an output circuit or interface configured to receive information or data.

### BRIEF DESCRIPTION OF DRAWINGS

FIG. 1 is a diagram of a communication system to which an embodiment of this application is applicable;

FIG. 2A to FIG. 2F are diagrams of sensing scenarios to which an embodiment of this application is applicable;

FIG. 3 is a diagram of a network architecture to which an embodiment of this application is applicable;

FIG. 4 is a diagram of a scenario applicable to an embodiment of this application;

FIG. 5 is a diagram of a communication method for sensing applicable to an embodiment of this application;

FIG. 6 is a diagram of a communication method for sensing applicable to an embodiment of this application;

FIG. 7 is a diagram of a communication method for sensing applicable to an embodiment of this application;

FIG. 8 is a diagram of a communication method for sensing applicable to an embodiment of this application;

FIG. 9 is a block diagram of a structure of a communication apparatus applicable to an embodiment of this application; and

FIG. 10 is a block diagram of a structure of a communication architecture applicable to an embodiment of this application.

### DESCRIPTION OF EMBODIMENTS

The following describes technical solutions of this application with reference to accompanying drawings.

The technical solutions provided in this application may be applied to various communication systems, such as a 5th generation (5G) or new radio (NR) system, a long term evolution (LTE) system, an LTE frequency division duplex (FDD) system, and an LTE time division duplex (TDD) system. The technical solutions provided in this application may be further applied to a future communication system, for example, a 6th generation mobile communication system. The technical solutions provided in this application may be further applied to device-to-device (D2D) communication, vehicle-to-everything (V2X) communication, machine-to-machine (M2M) communication, machine type communication (MTC), an internet of things (IoT) communication system, or another communication system.

A terminal device in embodiments of this application includes various devices having a wireless communication function, and the terminal device may be configured to be connected to a person, an object, a machine, and the like. The terminal device may be widely used in various scenarios, such as cellular communication, D2D, V2X, peer-to-peer (P2P), M2M, MTC, IoT, virtual reality (VR), augmented reality (AR), industrial control, autonomous driving, telemedicine, a smart grid, smart furniture, a smart office, smart wearable, smart transportation, a smart city, an uncrewed aerial vehicle, a robot, remote sensing, passive sensing, positioning, navigation and tracking, and autonomous delivery. The terminal device may be a terminal in any one of the foregoing scenarios, for example, an MTC terminal or an IoT terminal. The terminal device may be user equipment (UE) in a 3rd generation partnership project (3GPP) standard, a terminal, a fixed device, a mobile station device or a mobile device, a subscriber unit, a handheld device, a vehicle-mounted device, a wearable device, a cellular phone, a smartphone, a SIP phone, a wireless data card, a personal digital assistant (PDA), a computer, a tablet computer, a notebook computer, a wireless modem, a handset, a laptop computer, a computer having a wireless transceiver function, a smart book, a vehicle, a satellite, a global positioning system (GPS) device, a target tracking device, an aircraft (for example, an unmanned aerial vehicle, a helicopter, a multi-helicopter, a quadcopter, or an airplane), a ship, a remote control device, a smart home device, an industrial device, an apparatus built in the foregoing device (for example, a communication module, a modem, or a chip in the foregoing device), or another processing device connected to a wireless modem. For ease of description, an example in which the terminal device is a terminal or UE is used below for description.

In embodiments of this application, an apparatus for implementing a function of the terminal device may be a terminal device, or may be an apparatus that can support a terminal device in implementing the function, for example, a chip system or a chip. The apparatus may be mounted in the terminal device. In embodiments of this application, the chip system may include a chip, or may include a chip and another discrete component.

A network device in embodiments of this application may be a device for communicating with the terminal device. The network device may also be referred to as an access network device or a radio access network device. For example, the network device may be a base station. The network device in embodiments of this application may be a radio access network (RAN) node (or device) that connects the terminal device to a wireless network. The base station may cover any of the following names in a broad sense, or may be replaced with the following names, such as a NodeB, an evolved NodeB (eNB), a next generation NodeB (gNB), a relay station, an access point, a transmitting and receiving point (TRP), a transmitting point (TP), a primary station, a secondary station, a motor slide retainer (MSR) node, a home base station, a network controller, an access node, a wireless node, an access point (AP), a transmission node, a transceiver node, a baseband unit (BBU), a remote radio unit (RRU), an active antenna unit (AAU), a radio frequency head (RRH), a central unit (CU), a distributed unit (DU), and a positioning node. The base station may be a macro base station, a micro base station, a relay node, a donor node, or the like, or a combination thereof. The base station may alternatively be a communication module, a modem, or a chip disposed in the foregoing device or apparatus. The base station may alternatively be a mobile switching center, a device that bears a base station function in D2D, V2X, and M2M communication, a network side device in a 6G network, a device that bears a base station function in a future communication system, or the like. The base station may support networks of a same access technology or different access technologies. A specific technology and a specific device form that are used by the network device are not limited in embodiments of this application.

In embodiments of this application, an apparatus configured to implement a function of the network device may be a terminal device, or may be an apparatus that can support the network device in implementing the function, for example, a chip system or a chip. The apparatus may be mounted in the network device. In embodiments of this application, the chip system may include a chip, or may include a chip and another discrete component.

The network device and the terminal device may be deployed on land, including being deployed indoors or outdoors, or in a handheld manner or a vehicle-mounted manner; may be deployed on water; or may be deployed on an airplane, a balloon, and a satellite in the air. A scenario in which the network device and the terminal device are located is not limited in embodiments of this application.

First, a network architecture applicable to embodiments of this application is briefly described as follows.

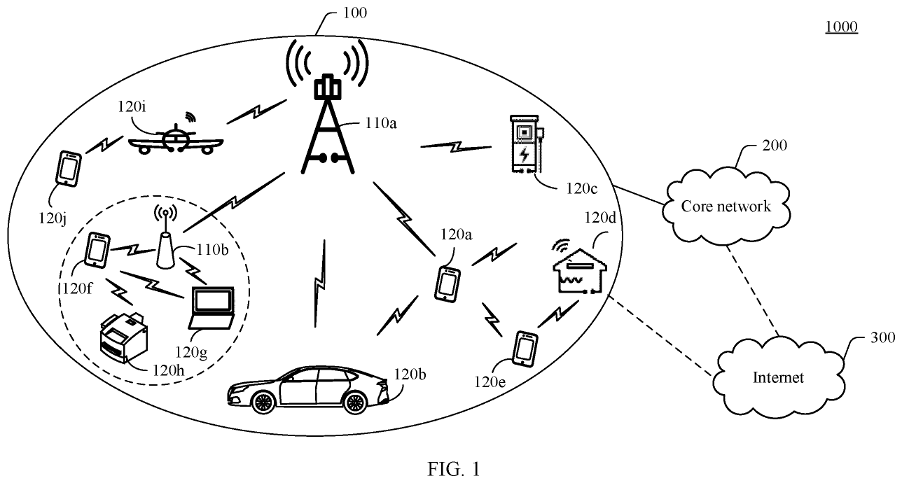

FIG. 1 is a diagram of a wireless communication system 100 to which an embodiment of this application is applicable. As shown in FIG. 1, the wireless communication system 100 may include at least one network device, for example, a network device 110 shown in FIG. 1. The wireless communication system 100 may further include at least one terminal device, for example, a terminal device 120 and a terminal device 130 shown in FIG. 1. A plurality of antennas may be configured for both the network device and the terminal device, and the network device and the terminal device may communicate with each other by using a multi-antenna technology. The terminal devices may also communicate with each other. For example, the terminal devices may directly communicate with each other. For another example, the terminal devices may communicate with each other via another communication device, for example, a network device or another terminal device.

When the network device communicates with the terminal device, the network device may manage one or more cells, and one cell may have an integer quantity of terminal devices. Optionally, the network device 110 and the terminal device 120 form one single-cell communication system. Without loss of generality, the cell is referred to as a cell #1. The network device 110 may be a network device in the cell #1, or the network device 110 may serve a terminal device (for example, the terminal device 120) in the cell #1.

It should be noted that the cell may be understood as a zone within coverage of a radio signal of the network device.

It should be understood that FIG. 1 is merely a simplified diagram of an example for ease of understanding. The wireless communication system 100 may further include another network device or may further include another terminal device, which is not shown in FIG. 1. Embodiments of this application are applicable to any communication scenario in which a transmitter device communicates with a receiver device.

For ease of understanding of embodiments of this application, terms in embodiments of this application are first briefly described below.

1. Integrated sensing and communication (ISAC):

In the communication field, two functions of communication and sensing may be integrated, so that a communication system has both the communication function and the sensing function. To be specific, the communication system supports both information transmission on a radio channel and sensing of a physical feature of an ambient environment by actively recognizing and analyzing a channel feature, so as to implement mutual enhancement of the communication and sensing functions. In the integrated sensing and communication technology, a sensing device may send a sensing signal, and receive a signal (also referred to as an echo signal) obtained after the sent sensing signal is reflected by a sensed target, to determine attribute information of the sensed target. For example, the information of the sensed target includes a velocity, a distance, a shape, or a size. The sensed target may be a fixed object, for example, a mountain, a forest, or a building, or may be a movable object, for example, a vehicle, an uncrewed aerial vehicle, a pedestrian, or a terminal device. The sensing device may also be referred to as a sensing apparatus, or may be referred to as a detector or the like, or may be referred to as a communication device (like a terminal device or an access network device) having a sensing function. The sensing function may include at least a capability of sending a sensing signal and receiving an echo signal of the sensing signal.

2. Self-sensing:

In this application, the self-sensing means implementing sensing measurement on a sensing target by receiving a sensing signal sent by the sensing target. For example, in wireless communication, the self-sensing may include sensing of transmit power, sensing of signal quality, and the like. For example, a transmit end transmits a sensing signal, and the sensing signal is received by the transmit end after being reflected by the sensing target. The transmit end may obtain a distance of the sensing target based on transmit time and receive time of the sensing signal. The self-sensing technology is applied to many fields, such as smart transportation, smart city, and smart home. The self-sensing may also be referred to as a monostatic sensing mode. In terms of a sensing signal procedure, a sensing site not only needs to send the sensing signal, but also needs to receive a reflected signal of the sensing signal from a surface of a target. Therefore, the monostatic sensing mode is also referred to as a self-sending and self-receiving mode.

3. Receiving and sending separation sensing:

In this application, the receiving and sending separation sensing means separately performing receiving and sending functions. The receiving and sending separation sensing can achieve better signal receiving and sending effects, and can also reduce system complexity and improve system stability. For example, a receiving and sending separation sensing system includes two parts: a transmit end and a receive end. The transmit end is used for transmitting a sensing signal. The sensing signal is received by the receive end after being reflected by a sensing target. The receive end processes the sensing signal to obtain information about the sensing target. The receiving and sending separation sensing technology is applied to many fields, such as wireless communication, satellite communication, and radar. This technology can improve transmission efficiency and reliability of the communication system, and reduce complexity and costs of the system. The receiving and sending separation sensing may also be referred to as a bistatic sensing mode. In terms of the sensing signal procedure, the transmit end and the receive end of the sensing signal are two different devices. In terms of the sensing signal procedure, after a sensing site A sends a sensing signal, a reflected signal of the signal from a surface of a target is received by a sensing site B. Therefore, the bistatic sensing mode is also referred to as an A-sending B-receiving mode.

It may be understood that, in a monostatic sensing scenario, the access network device may perform self-sending and self-receiving, or the terminal device may perform self-sending and self-receiving. In a bistatic sensing scenario, an access network device A may perform sending and an access network device B may perform receiving, or an access network device may perform sending and UE may perform receiving, or UE may perform sending and an access network device may perform receiving, or UE #1 may perform sending and UE #2 may perform receiving.

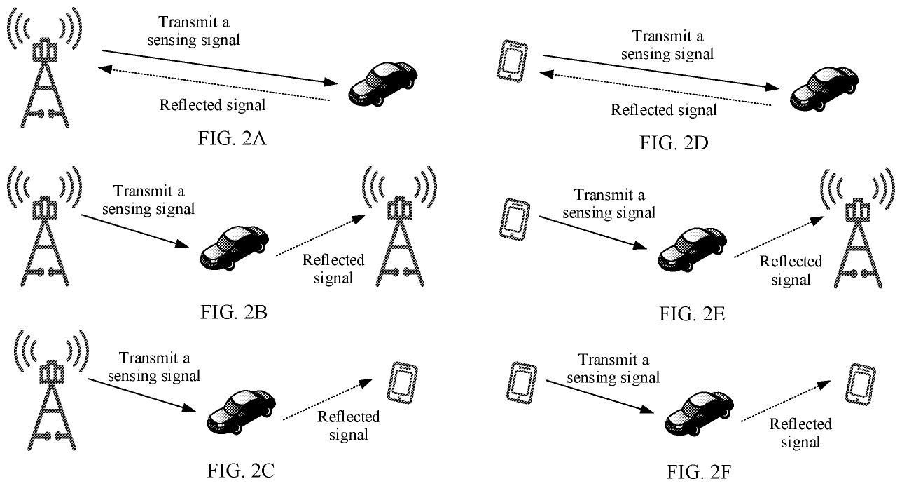

FIG. 2A to FIG. 2F are diagrams of sensing scenarios to which an embodiment of this application is applicable. FIG. 2A to FIG. 2F show six sensing scenarios.

FIG. 2A shows a sensing scenario in which the access network device A performs self-sending and self-receiving. The access network device A transmits a sensing signal, and the access network device A receives a reflected signal generated when the sensing signal encounters a target in an environment, to sense information such as a position and a velocity of the target. FIG. 2B shows a sensing scenario in which the access network device A performs sending and the access network device B performs receiving. The access network device A transmits a sensing signal, and the access network device B receives a reflected signal generated when the sensing signal encounters a target in an environment, to sense information such as a position and a velocity of the target through the access network device B. FIG. 2C shows a sensing scenario in which the access network device A performs sending and the terminal device performs receiving. The access network device A transmits a sensing signal, and the terminal device receives a reflected signal generated when the sensing signal encounters a target in an environment, to sense information such as a position and a velocity of the target through the terminal device.

FIG. 2D shows a sensing scenario in which the UE performs self-sending and self-receiving. The UE #1 transmits a sensing signal, and the UE #1 receives a reflected signal generated when the sensing signal encounters a target in an environment, to sense information such as a position and a velocity of the target. FIG. 2E shows a sensing scenario in which the UE #1 performs sending and the access network device performs receiving. The UE #1 transmits a sensing signal, and the access network device B receives a reflected signal generated when the sensing signal encounters a target in an environment, to sense information such as a position and a velocity of the target through the access network device B. FIG. 2F shows a sensing scenario in which the UE #1 performs sending and the UE #2 performs receiving. The UE #1 transmits a sensing signal, and the UE #2 receives a reflected signal generated when the sensing signal encounters a target in an environment, to sense information such as a position and a velocity of the target through the UE #2.

The foregoing sensing scenarios are merely examples for description, and do not constitute any limitation on embodiments of this application.

In this application, the sensed target includes various tangible objects that can reflect an electromagnetic wave in an environment, for example, a ground object like a mountain, a forest, or a building, or may be a movable object like a vehicle, an uncrewed aerial vehicle, a pedestrian, or a terminal device. The sensed target may also be referred to as a target, a detected target, a sensed object, a detected object, a sensed device, or the like. This is not limited in embodiments of this application.

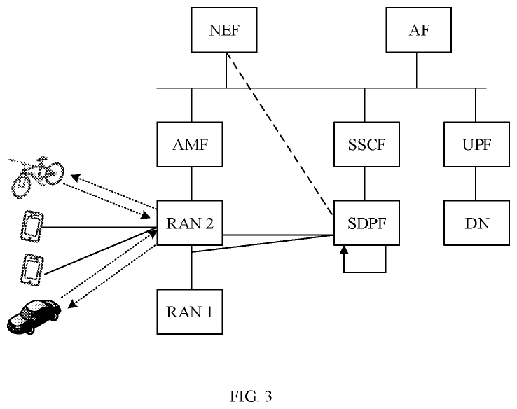

FIG. 3 is a diagram of a network architecture to which an embodiment of this application is applicable.

As shown in FIG. 3, the network architecture includes but is not limited to the following network elements:

1. Network exposure function (NEF) network element:

The NEF network element is configured to: securely expose a service, a capability, and the like provided by a 3GPP network function, and mainly support secure interaction between the 3GPP network and a third-party application.

2. Application function (AF) network element:

The AF network element is configured to: perform application-affected data routing, access a network exposure function network element, interact with a policy framework to perform policy control, or the like, for example, affect a data routing decision and a policy control function or provide some third-party services for a network side.

3. Access and mobility management function (AMF) network element:

The AMF network element is mainly used for mobility management, access management, and the like, and may be configured to implement functions, for example, lawful interception and access authorization/authentication, other than session management in functions of a mobility management entity (MME) in an LTE system. When providing a service for a session in user equipment, the AMF network element provides a control plane storage resource for the session, to store a session identifier, an SMF network element identifier associated with the session identifier, and the like. In embodiments of this application, the AMF network element may be configured to implement a function of an access and mobility management network element.

4. User plane function (UPF) network element:

The UPF network element may be configured to: perform packet routing and forwarding, perform quality of service (QoS) processing on user plane data, or the like. User data may be accessed to a data network (DN) through the network element, or may be received from the data network and transmitted to user equipment through an access network device. A transmission resource and a scheduling function that are used by the UPF network element to provide a service for the user equipment are managed and controlled by an SMF network element. In embodiments of this application, the UPF network element may be configured to implement a function of a user plane network element.

5. Access device (AN):

The access device in embodiments of this application may be a device configured to communicate with user equipment, and the access device may also be referred to as an access network device or a radio access network device. For example, the access device may be an evolved NodeB (eNB or eNodeB) in an LTE system; and may be a radio controller in a cloud radio access network (CRAN) scenario. Alternatively, the access device may be a relay station, an access point, a vehicle-mounted device, a wearable device, an access device in a 5G network, an access device in a future evolved PLMN network, or the like; may be an access point (AP) in a WLAN; or may be a gNB in an NR system. This is not limited in embodiments of this application. FIG. 3 shows two RAN devices, namely, a RAN 1 and a RAN 2.

In addition, in embodiments of this application, the access device is a device in a RAN. In other words, the access device is a RAN node that connects the user equipment to a wireless network. For example, by way of example, and not limitation, the access device may be a gNB, a transmission reception point (TRP), an evolved NodeB (eNB), a radio network controller (RNC), a NodeB (NB), a base station controller (BSC), a base transceiver station (BTS), a home evolved NodeB (for example, a home evolved NodeB or a home NodeB, HNB), a baseband unit (BBU), or a wireless fidelity (Wi-Fi) access point (AP). In a network structure, a network device may include a central unit (CU) node, a distributed unit (DU) node, a RAN device including a CU node and a DU node, or a RAN device including a CU control plane node (CU-CP node), a CU user plane node (CU-UP node), and a DU node.

The access device may serve a cell. User equipment communicates with the access device on a transmission resource (for example, a frequency domain resource, or in other words, a frequency spectrum resource) used for the cell. The cell may be a cell corresponding to the access device (for example, a base station). The cell may belong to a macro base station, or a base station corresponding to a small cell. The small cell herein may include a metro cell, a micro cell, a pico cell, a femto cell, or the like. These small cells have features of small coverage and low transmit power, and are applicable to providing a high-velocity data transmission service.

In addition, a plurality of cells may simultaneously operate in a same frequency band on a carrier in the LTE system or the 5G system. In some special scenarios, it may also be considered that a concept of the carrier is equivalent to that of a cell. For example, in a carrier aggregation (CA) scenario, when a secondary component carrier is configured for UE, both a carrier index of the secondary component carrier and a cell identification (Cell ID) of a secondary cell that operates on the secondary component carrier are carried. In this case, it may be considered that a concept of a carrier is equivalent to that of a cell. For example, accessing a carrier by the user equipment is equivalent to accessing a cell by the user equipment.

The communication system in this application may be further applicable to a vehicle to everything (V2X) technology. To be specific, the user equipment in this application may alternatively be a vehicle, for example, an intelligent vehicle or an autonomous vehicle.

Herein, “X” in V2X represents different communication targets, and V2X may include but is not limited to vehicle to vehicle (V2V), vehicle to infrastructure (V2I), vehicle to network (V2N), and vehicle to pedestrian (V2P).

In the V2X, the access device may configure a “zone” for the UE. The zone may also be referred to as a geographical zone. After the zone is configured, the world is divided into a plurality of zones, and the zones are defined by reference points, lengths, and widths. When determining an identifier (ID) of a zone, the UE performs a remainder operation by using a length of the zone, a width of the zone, a quantity of zones in terms of length, a quantity of zones in terms of width, and a reference point. The foregoing information may be configured by the access device.

A V2X service may be provided in two manners: a proximity-based services communication (PC5) interface manner and an Uu interface-based manner. A PC5 interface is an interface defined based on a sidelink, and communication devices (for example, vehicles) may directly communicate with each other through the PC5 interface. The PC5 interface may be used out of coverage (OOC) and in coverage (IC), but only an authorized communication device can use the PC5 interface for transmission.

The access network device in this application has a sensing capability, and may be used as a sensing entity to send a sensing signal to a sensing target and receive a sensing echo signal. Alternatively, an echo signal may be received by another sensing entity. Alternatively, an echo signal of a sensing signal sent by another sensing entity may be received. For details, refer to the scenario in FIG. 2A to FIG. 2F. This is not limited in embodiments of this application.

6. Sensing service control function (SSCF):

A main function of the SSCF is to receive capability registration of a sensing entity and orchestrate a sensing service.

In a capability registration phase of the sensing entity, the sensing entity may send a capability registration request message to the SSCF. The capability registration request message includes parameters such as indication information of the sensing entity, indication information of a sensing entity adjacent to the sensing entity, position information of the sensing entity, and a sensing range of the sensing entity. After the registration is completed, the SSCF may send a sensing capability registration response message to the sensing entity, to notify the sensing entity that the registration of the sensing capability is completed.

The indication information of the sensing entity may be an identifier or a name of the sensing entity. This is not limited in embodiments of this application.

In an orchestration phase of the sensing service, the SSCF may determine a sending entity and a receiving entity of a sensing signal based on a service requirement. For example, the SSCF may select a proper sensing entity as the sending entity based on a sensing service request, and send a sensing control message to the RAN, where the sensing control message may include a sensing signal Tx, a sensing type, a KPI of the sensing service, and the like. Similarly, the SSCF may select a proper sensing entity as the receiving entity based on the sensing service request, and send a sensing control message to the UE, where the sensing control message may include a sensing signal Rx, a sensing type, and the like.

The SSCF may communicate with another NF through a service based interface (service based interface, SBI).

7. Sensing data processing function (SDPF):

The SDPF is used to process sensing service data.

A sensing entity may send original sensing data to the SDPF. The SDPF may obtain sensing measurement data through calculation based on the original sensing data, obtain a sensing result through calculation based on the sensing measurement data, and send a processing result to the DN. For example, the processing result may be sent to the DN through an NEF or a gateway (GW). This is not limited in embodiments of this application.

The SDPF may be connected to an SBI bus, or an independent interface may be defined.

In this application, the RAN may be directly connected to the SSCF, or may perform forwarding through the AMF. This is not limited in embodiments of this application.

In this application, sensing data of the RAN or the UE may be forwarded to the SDPF through the UPF, or may be directly sent to the SDPF. This is not limited in embodiments of this application.

It should be understood that the network architecture shown above is merely an example for description, and the network architecture applicable to embodiments of this application is not limited thereto. Any network architecture that can implement functions of the network elements is applicable to embodiments of this application.

It should be further understood that the functions or network elements shown in the figure may be understood as network elements configured to implement different functions, for example, may be combined into a network slice based on a requirement. These network elements may be independent devices, may be integrated into a same device to implement different functions, may be network elements in a hardware device, may be software functions running on dedicated hardware, or may be virtualization functions instantiated on a platform (for example, a cloud platform). Specific forms of the network elements are not limited in this application.

It should be further understood that the foregoing names are defined merely for ease of distinguishing between different functions, and should not constitute any limitation on this application. This application does not exclude a possibility of using other names in a 6G network and another future network. For example, in the 6G network, a part or all of the foregoing network elements may still use terms in 5G, or may use other names.

In this application, in a wireless sensing service scenario involving a plurality of sensing entities, the plurality of sensing entities collect data and collaborative to complete a sensing service. Due to mobility of the sensing target, when the sensing target moves out of an effective sensing range of a current sensing entity within coverage of the sensing service, continuity of the sensing service needs to be ensured.

In view of this, an embodiment of this application provides a communication method for sensing, to ensure continuity of a wireless sensing service when a sensing target moves.

With reference to the accompanying drawings, the following describes in detail a communication method provided in embodiments of this application. Embodiments provided in this application may be applied to the communication system shown in FIG. 1. This is not limited.

The following describes in detail the solution of this application.

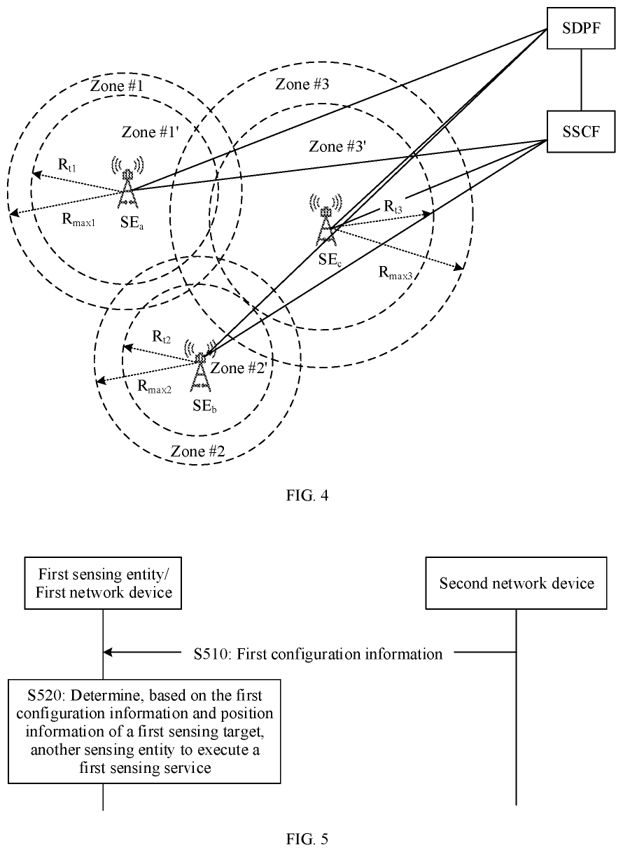

FIG. 4 is a diagram of a scenario applicable to an embodiment of this application.

The scenario may include an SDPF and an SSCF.

The scenario may further include a plurality of sensing entities, for example, SEₐ, SE_{b}, and SE_{c} shown in FIG. 4. Each of the three sensing entities has a sensing service range.

The sensing service range of each sensing entity may be understood as an effective sensing coverage area. To be specific, within the coverage range, the sensing entity may generate valid sensing data for a sensing target. Once the sensing target exceeds the sensing range, the sensing data may be considered invalid.

In this application, the sensing service range of the sensing entity is determined based on respective performance of the sensing entity, and the sensing service range may be an irregular zone. For ease of understanding, in this application, the sensing service range of the sensing entity is described by using a circular zone as an example.

In this application, a maximum effective sensing distance Rₘₐₓ relative to the sensing entity is determined based on the performance of the sensing entity. As shown in FIG. 4, a sensing service range of SEₐ is a circular zone #1 whose circle center is a position of SEₐ and whose radius is Rₘₐₓ₁. A sensing service range of SE_{b} is a circular zone #2 whose circle center is a position of SE_{b} and whose radius is Rₘₐₓ₂. A sensing service range of SE_{c} is a circular zone #3 whose circle center is a position of SE_{c} and whose radius is Rₘₐₓ₃. When the sensing target moves in the zone #1, SEₐ may sense the sensing target and send sensing data to the SDPF. When the sensing target moves in the zone #2, SE_{b} may sense the sensing target and send sensing data to the SDPF. When the sensing target moves in the zone #3, SE_{c} may sense the sensing target and send sensing data to the SDPF.

In this application, the SSCF may determine, based on a service requirement of a sensing service, an effective distance Rt for ensuring continuity of the sensing service. As shown in FIG. 4, a service range of SEₐ for continuity of the sensing service is a circular zone #1′ whose circle center is the position of SEₐ and whose radius is Rₜ₁. A service range of SE_{b} for continuity of the sensing service is a circular zone #2′ whose circle center is the position of SE_{b} and whose radius is Rₜ₂. A service range of SE_{c} for continuity of the sensing service is a circular zone #3′ whose circle center is the position of SE_{c} and whose radius is Rₜ₃. When the sensing target moves in the zone #1′, SEₐ may sense the sensing target and ensure continuity of the sensing service. When the sensing target moves in the zone #2′, SE_{b} may sense the sensing target and ensure continuity of the sensing service. When the sensing target moves in the zone #3′, SE_{c} may sense the sensing target and ensure continuity of the sensing service.

The SSCF may determine, based on a service KPI of the sensing service, the effective distance Rt for ensuring continuity of the sensing service. When a distance between the sensing target and the sensing entity does not exceed Rt, continuity of the sensing service may be ensured. When the distance between the sensing target and the sensing entity exceeds Rₜ, the continuity of the sensing service may be affected.

It should be noted that, in this application, the effective distance Rₜ for ensuring continuity of the sensing service is different from the maximum effective sensing distance Rₘₐₓ of the sensing entity. Once the sensing target moves out of the service range for ensuring continuity of the sensing service, the continuity of the sensing service may be affected, but the sensing target may still be within the sensing service range. Although the sensing data of the sensing entity is valid, the continuity of the sensing service cannot be ensured due to reasons such as weak signal quality or a large signal quality change.

In this application, the effective distance Rₜ for ensuring continuity of the sensing service may also be referred to as a maximum range of the sensing entity for a service requirement of the sensing service.

The following describes in detail a method for ensuring continuity of a sensing service based on the effective distance Rₜ for ensuring continuity of the sensing service.

FIG. 5 is a diagram of a communication method for sensing applicable to an embodiment of this application. For ease of description, the following uses an example in which a method 500 is performed by a first sensing entity/a first network device for communication with a second network device and a second sensing entity for description.

In this application, a sensing entity may include a device having a sensing capability, like an access network device or a terminal device. When a sensing target moves in a scenario in which a plurality of sensing entities collaborate for sensing, the plurality of sensing entities may sense the sensing target within respective sensing ranges. In this application, an example in which the plurality of sensing entities are the first sensing entity and the second sensing entity is used. Certainly, the plurality of sensing entities may further include a third sensing entity, and the like. This is not limited in embodiments of this application.

For example, the first network device is a network entity having a sensing data processing function, for example, an SDPF.

For example, the second network device is a network entity having a sensing service control function, for example, an SSCF.

S510: The first sensing entity or the first network device receives first configuration information.

In this application, the second network device may send the first configuration information to the first network device or the first sensing entity.

The first configuration information includes a first threshold, and the first threshold indicates a sensing range of the first sensing entity for a first sensing service. It should be noted that the sensing range for the first sensing service is related to a service requirement of the first sensing service. For example, a higher service requirement (for example, quality of service requirement) of the first sensing service indicates a smaller sensing range for the first sensing service.

In a possible implementation, the second network device may further send the first configuration information to a sensing entity adjacent to the first sensing entity, for example, send the first configuration information to the second sensing entity. The first configuration information may further include a second threshold, and the second threshold indicates a sensing range of the second sensing entity for the first sensing service.

The first threshold and the second threshold may also be understood as an effective distance for ensuring service continuity of the first sensing service, namely, Rₜ described above.

In this application, the first threshold and the second threshold are respectively determined by the second network device for the first sensing entity and the second sensing entity based on the service requirement of the first sensing service.

For example, the second network device determines the first threshold and the second threshold based on a service key performance indicator (KPI) of the first sensing service.

It may be understood that, for different sensing entities, service requirements of a same sensing service (for example, the first sensing service) may be different. Therefore, effective distances for ensuring service continuity may be different accordingly. Certainly, effective distances for different sensing entities may alternatively be the same. In other words, the first threshold and the second threshold may be the same or different. This is not limited in embodiments of this application.

In this application, the first configuration information may further include information about a third sensing entity adjacent to the first sensing entity. For example, the first configuration information may further include a third threshold. In addition, the first configuration information is sent to the third sensing entity. This is not limited in embodiments of this application.

S520: The first sensing entity/the first network device determines, based on the first configuration information and position information of a first sensing target, another sensing entity to execute the first sensing service.

In this application, when the first sensing target moves within a sensing range of the first sensing entity for ensuring continuity of the sensing service, the first sensing service may be implemented based on sensing on the first sensing target, in other words, the service requirement of the first sensing service is met. The first sensing entity or the first network device may determine, based on the position information of the first sensing target, whether the first sensing target is currently within the sensing range of the first sensing entity for ensuring the continuity of the sensing service. The position information of the first sensing target indicates a position of the first sensing target, for example, may be information about a distance between the first sensing target and the first sensing entity (or another sensing entity), or may be coordinate information of a physical position of the first sensing target, or may be position information of the first sensing target in a signal strength distribution diagram determined based on signal strength between the first sensing target and the first sensing entity (or another sensing entity), or may be other information that can indicate a physical position or a signal distribution diagram position of the first sensing target.

For example, the position information of the first sensing target includes a first distance. The first distance is a distance between the position of the first sensing target and a position of the first sensing entity.

In a possible implementation, the first sensing entity or the first network device determines that the first distance exceeds an effective distance within which the first sensing entity (namely, the first network device) ensures the continuity of the sensing service, and the service continuity of the first sensing service may not be maintained. In this case, another sensing entity may be determined to execute the first sensing service.

It may be understood that the first sensing target is in a moving state. When the first sensing target has moved out of or is about to move out of the sensing range for ensuring the service continuity of the sensing service, another sensing entity may be determined to execute the first sensing service, to ensure the continuity of the first sensing service.

In a possible implementation, the first sensing entity/the first network device determines the first distance, and when the first distance is greater than or equal to the first threshold, determines another sensing entity to execute the first sensing service.

The first distance is the distance between the first sensing target and the first sensing entity.

The first sensing entity may determine the first distance based on a sensing capability.

The first network device may obtain the first distance through the first sensing entity.

The following describes an example of a manner of determining another sensing entity.

In a possible implementation, the first sensing entity/the first network device may determine first request information based on the first configuration information.

The first request information is used to request the second sensing entity to execute the first sensing service.

Further, the first sensing entity/the first network device may send the first request information to the second sensing entity.

For example, the first sensing entity/the first network device may determine a target sensing entity, namely, the second sensing entity, based on an algorithm. This is not limited in embodiments of this application.

The first request information may include indication information of the first sensing service, indication information of the first sensing entity (for example, an identifier or a name of the first sensing entity), indication information of the second sensing entity (for example, an identifier or a name of the second sensing service), and sensing information.

In this application, the indication information of the first sensing service may be, for example, an identifier or a name of the first sensing service, or may be other information indicating the first sensing service. This is not limited in this application. The indication information of the first sensing entity may be, for example, the identifier or the name of the first sensing entity, or may be other information indicating the first sensing entity. This is not limited in this application. The indication information of the second sensing entity may be, for example, an identifier or a name of the second sensing entity, or may be other information indicating the second sensing entity. This is not limited in this application. Details are not described again below.

In this application, either the first sensing entity or the first network device may determine, based on the first configuration information, another sensing entity to execute the first sensing service.

When the first sensing entity determines another sensing entity based on the first configuration information, in a possible manner, the first configuration information may further include indication information of a sensing entity (for example, an identifier or a name of the sensing entity) and a first determining mode. The indication information of the sensing entity includes the indication information of the first sensing entity and indication information of a sensing entity adjacent to the first sensing entity, for example, the identifier of the first sensing entity, an identifier of the second sensing entity, and an identifier of the third sensing entity. The first determining mode indicates the first sensing entity to determine another sensing entity.

It may be understood that the first determining mode indicates the first sensing entity to determine another sensing entity to execute the first sensing service, and the first sensing entity may determine the another sensing entity based on sensing capability information and position information of an adjacent sensing entity.

For example, the first configuration information may further include maximum effective sensing distances of the second sensing entity and the third sensing entity and position information of the second sensing entity and the third sensing entity.

When the first network device determines another sensing entity based on the first configuration information, in another possible manner, the first configuration information may further include indication information of a sensing entity (for example, an identifier or a name of the sensing entity) and a second determining mode. The indication information of the sensing entity includes the indication information of the first sensing entity and indication information of a sensing entity adjacent to the first sensing entity, for example, the identifier of the first sensing entity, an identifier of the second sensing entity, and an identifier of the third sensing entity. The second determining mode indicates the first network device to determine another sensing entity.

It may be understood that the second determining mode indicates the first sensing entity to determine another sensing entity to execute the first sensing service, and the first network device may determine the another sensing entity based on sensing capability information and position information of a sensing entity adjacent to the first sensing entity.

For example, the first configuration information may further include maximum effective sensing distances of the second sensing entity and the third sensing entity and position information of the second sensing entity and the third sensing entity.

In this application, the second sensing entity receives the first request information, and senses the first sensing target based on the first request information.

It may be understood that the first sensing target may be in the moving state. When the first sensing target has entered a sensing range of the second sensing entity for the service requirement of the first sensing service, the first sensing entity may stop sensing.

In this application, the second sensing entity or the first network device may determine, based on the position information of the first sensing target, whether the first sensing target is currently within the sensing range of the second sensing entity for ensuring the continuity of the sensing service.

For example, the position information of the first sensing target includes a second distance. The second distance is a distance between the position of the first sensing target and a position of the second sensing entity.

In a possible implementation, when determining that the second distance is less than the second threshold, the second sensing entity or the first network device may send second request information to the first sensing entity, where the second request information is used to request the first sensing entity to stop executing the first sensing service.

It may be understood that, the second sensing entity may determine that the first sensing target has entered the sensing range of the second sensing entity for the service requirement of the first sensing service, or the first network device may determine, based on sensing data, that the first sensing target has entered the sensing range of the second sensing entity for the service requirement of the first sensing service, so that the second sensing entity may be indicated to stop sensing.

Correspondingly, the first sensing entity receives the second request information sent from the second sensing entity or the first network device, and stops executing the first sensing service.

It should be understood that, before the first sensing entity receives the second request information, both the first sensing entity and the second sensing entity sense the first sensing target, and send sensing data to the SDPF.

For example, as shown in FIG. 4, when the sensing target moves out of a zone 1′ and is about to enter a zone 2′, and moves between the zone 1′ and the zone 2′, the first sensing entity and the second sensing entity simultaneously execute the first sensing service. When the sensing target enters the zone 2′, in other words, the second distance is less than the second threshold, the first sensing entity may stop executing the first sensing service.

In this application, when determining another sensing entity, the first sensing entity or the first network device may further request the second network device to determine the second sensing entity.

In a possible implementation, the first sensing entity/the first network device may send third request information to the second network device, where the third request information is used to request the second network device to determine the second sensing entity.

The third request information includes indication information of the first sensing service, indication information of the first sensing entity, and sensing information.

The first configuration information further includes the indication information of the first sensing service and a third determining mode, and the third determining mode indicates the second network device to determine the second sensing entity.

It may be understood that the third determining mode indicates the second network device to determine another sensing entity to execute the first sensing service, and the second network device may determine the another sensing entity based on sensing capability information and position information of a sensing entity adjacent to the first sensing entity.

It should be noted that, in a registration phase, the second network device may obtain indication information (for example, an identifier or a name of each sensing service), sensing capability information, and position information of the first sensing entity and the sensing entity adjacent to the first sensing entity.

For example, the second network device may obtain maximum effective sensing distances of the first sensing entity, the second sensing entity, and the third sensing entity, and position information of the second sensing entity and the third sensing entity.

In this application, the second network device may determine the target sensing entity, namely, the second sensing entity, based on an algorithm. This is not limited in embodiments of this application.

In a possible implementation, the second network device sends fourth request information to the second sensing entity, where the fourth request information is used to request the second sensing entity to execute the first sensing service.

The fourth request information includes indication information of the first sensing service, indication information of the first sensing entity, indication information of the second sensing entity, and sensing information.

In this application, the second sensing entity receives the fourth request information, and senses the first sensing target based on the fourth request information.

It may be understood that the first sensing target may be in the moving state. When the first sensing target has entered a sensing range of the second sensing entity for the service requirement of the first sensing service, the first sensing entity may stop sensing.

In a possible implementation, when the second sensing entity determines that the second distance is less than the second threshold, the second sensing entity may send the second request information to the first sensing entity, where the second request information is used to request the first sensing entity to stop executing the first sensing service; or may send fifth request information to the second network device, where the fifth request information is used to request the first sensing entity to stop executing the first sensing service, and the second network device may send sixth request information to the first sensing device, where the sixth request information is used to request the first sensing entity to stop executing the first sensing service.

The second distance is a distance between the first sensing target and the second sensing entity.

Correspondingly, the first sensing entity receives the second request information or the sixth request information sent from the second sensing entity or the second network device, and stops executing the first sensing service.

It should be understood that, before the first sensing entity receives the second request information or the sixth request information, the first sensing entity and the second sensing entity sense the first sensing target simultaneously, and send sensing data to the SDPF.

In this application, the first sensing entity and the second sensing entity may be access network devices or terminal devices, the first network device may have a sensing data processing function, and the second network device may have a sensing service control function.

In the foregoing solution, that the first sensing entity or the first network device determines, based on the effective distance for the service requirement of the first sensing service, another sensing entity to execute the first sensing service is described. The following describes in detail specific solutions in different scenarios.

First, an example solution in which the first sensing entity determines another sensing entity to execute the first sensing service is described.

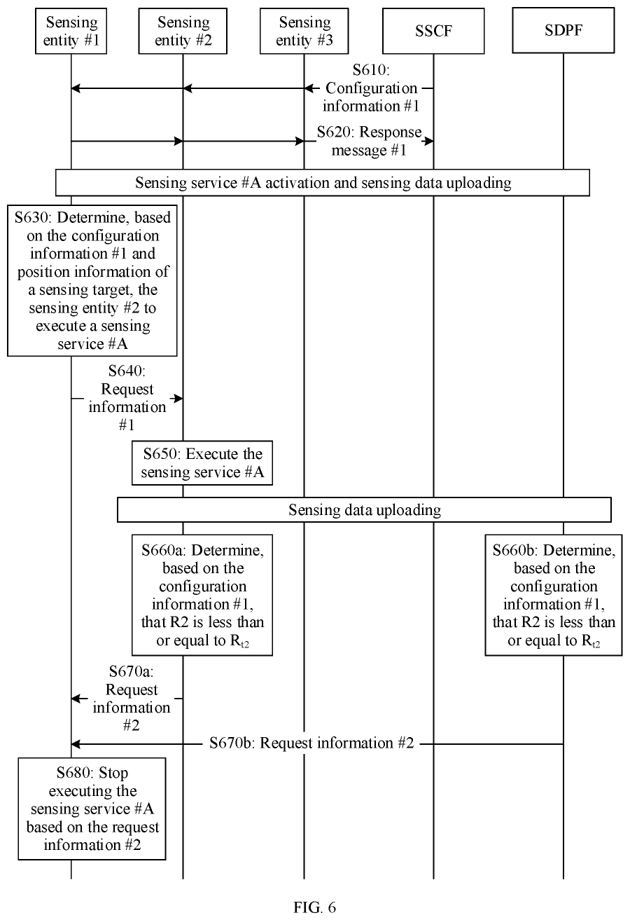

FIG. 6 is a diagram of a communication method for sensing applicable to an embodiment of this application.

In this embodiment, a sensing entity includes a sensing entity #1, a sensing entity #2, and a sensing entity #3. An example in which a first network device is an SDPF, a second network device is an SSCF, and a first sensing service is a sensing service #A is used.

A method 600 may specifically include the following steps.

S610: The SSCF sends configuration information #1 to the sensing entity #1, the sensing entity #2, and the sensing entity #3.

The configuration information #1 may include indication information of the sensing service #A, indication information of the sensing entity #1, indication information of the sensing entity #2, indication information of the sensing entity #3, and sensing ranges (Rₜ₁ of the sensing entity #1, Rₜ₂ of the sensing entity #2, and Rₜ₃ of the sensing entity #3) of all sensing entities for a service requirement of the sensing service #A.

The indication information of the sensing service #A may be, for example, an identifier or a name of the sensing service #A. The indication information of the sensing entity #1 may be, for example, an identifier or a name of the sensing entity #1. The indication information of the sensing entity #2 may be, for example, an identifier or a name of the sensing entity #2.

In the following, to avoid repetition, an example in which the indication information of the sensing service #A is the identifier of the sensing service #A, the indication information of the sensing entity #1 is the identifier of the sensing entity #1, and the indication information of the sensing entity #2 is the identifier of the sensing entity #2 is used.

In an optional understanding, the SSCF sends, to each sensing entity, sensing ranges of the sensing entity #1 and an adjacent sensing entity for the service requirement of the sensing service #A.

The sensing ranges of the sensing entity #1 and the adjacent sensing entity for the service requirement of the sensing service #A are sent to each sensing entity by using the configuration information #1. In other words, the configuration information #1 may include the service identifier of the sensing service #A, the identifier of the sensing entity #1, the identifier of the sensing entity #2, and the identifier of the sensing entity #3 (Rₜ₁, Rₜ₂, and Rₜ₃).

Rₜ₁ is an example of a first threshold, and indicates the sensing range of the sensing entity #1 for the service requirement of the sensing service #A. Rₜ₂ is an example of a second threshold, and indicates the sensing range of the sensing entity #2 for the service requirement of the sensing service #A. Rₜ₃ is an example of a third threshold, and indicates the sensing range of the sensing entity #3 for the service requirement of the sensing service #A.

It should be understood that, Rₜ₁, Rₜ₂, and Rₜ₃ are determined by the SSCF based on the service requirement of the sensing service #A. To be specific, after a sensing target moves out of a sensing range that corresponds to a current sensing entity and that ensures continuity of a sensing service, the service continuity may be affected, and sensing data of the current sensing entity may be invalid in this case. In this case, another sensing entity may be determined to continue to execute the sensing service #A.

It may be understood that a maximum sensing range of the sensing entity is greater than the sensing range for ensuring the continuity of the sensing service. The sensing target moves out of the sensing range for ensuring the continuity of the sensing service, but is still within the maximum sensing range of the sensing entity. In this case, the continuity of the sensing service may not be ensured due to a distance problem of the sensing target, and the sensing data of the sensing entity may also be invalid.

The configuration information #1 may further include a determining mode #1, and the determining mode #1 indicates the sensing entity #1 to determine another sensing entity to execute the sensing service #A.

The configuration information #1 may further include a maximum effective sensing distance Rₘₐₓ₁ of the sensing entity #1, a maximum effective sensing distance Rₘₐₓ₂ of the sensing entity #2, and a maximum effective sensing distance Rₘₐₓ₃ of the sensing entity #3.

The configuration information #1 may further include position information of the sensing entity #1, the sensing entity #2, and the sensing entity #3.

S620: The sensing entity #1, the sensing entity #2, and the sensing entity #3 send a response message #1 to the SSCF.

After receiving the configuration information #1, each sensing entity may send the response message #1 to the SSCF.

S630: The sensing entity #1 determines, based on the configuration information #1 and position information of a sensing target, the sensing entity #2 to execute the sensing service #A.

The SSCF may activate the sensing entity #1 to execute the sensing service #A. For example, the SSCF may determine, based on the service requirement of the sensing service #A and current position information of the sensing target, that the sensing entity #1 may be activated to execute the sensing service #A.

The sensing entity #1 executes the sensing service #A, and sends sensing data to the SDPF.

The sensing entity #1 determines, based on the sensing data, that a distance between a current position of the sensing target and a position of the sensing entity #1 is R1. When R1 is greater than or equal to Rₜ₁, the sensing entity #1 determines another sensing entity to execute the sensing service #A.

It may be understood that, when R1 is greater than or equal to Rₜ₁, the sensing entity #1 may determine that the sensing target has moved out of or is about to move out of the sensing range for ensuring the service continuity of the sensing service. In this case, another sensing entity may be determined to execute the sensing service #A, to ensure the continuity of the sensing service #A.

For example, the sensing entity #1 may determine, based on an algorithm, the sensing entity #2 to execute the sensing service #A.

It may be understood that the sensing entity #1 may determine, based on the maximum effective sensing distances of the sensing entity #2 and the sensing entity #3, and position information of the sensing entity #2 and the sensing entity #3, a sensing entity to execute the sensing service #A.

Alternatively, the sensing entity #1 may determine the sensing entity #2 in another manner. This is not limited in embodiments of this application.

S640: The sensing entity #1 sends request information #1 to the sensing entity #2.

The request information #1 is used to request the sensing entity #2 to execute the sensing service #A.

The request information #1 may include the service identifier of the sensing service #A, the identifier of the sensing entity #1, the identifier of the sensing entity #2, sensing information, and the like.

S650: The sensing entity #2 executes the sensing service #A.

The sensing entity #2 executes the sensing service #A based on the request information #1.

The sensing entity #2 uploads sensing data to the SDPF.

When executing the sensing service #A, the sensing entity #2 may determine that the sensing target has entered the sensing range of the sensing entity #2 for the service requirement of the first sensing service. Alternatively, the SDPF may determine, based on the sensing data, that the sensing target has entered the sensing range of the sensing entity #2 for the service requirement of the first sensing service, to indicate the sensing entity #1 to stop sensing.

That the sensing entity #2 determines and indicates the sensing entity #1 to stop sensing may specifically include the following steps S660a and S670a. That the SDPF determines and indicates the sensing entity #1 to stop sensing may include the following steps S660b and S670b.

S660a: The sensing entity #2 determines, based on the configuration information #1, that R2 is less than or equal to Rₜ₂.

The sensing entity #2 determines, based on the sensing data, that a distance between a current position of the sensing target and a position of the sensing entity #2 is R2. When R2 is less than or equal to Rₜ₂, the sensing entity #2 determines that the sensing entity #1 may stop executing the sensing service #A.

It may be understood that, when R2 is less than or equal to Rₜ₂, the sensing entity #2 may determine that the sensing target has entered the sensing range of the sensing entity #2 for the service requirement of the first sensing service. In this case, another sensing entity may be determined to stop executing the sensing service #A, and the sensing entity #2 may ensure the continuity of the sensing service #A.

S660b: The SDPF determines, based on the configuration information #1, that R2 is less than or equal to Rₜ₂.

The SDPF determines, based on the sensing data of the sensing entity #2, that the distance between the current position of the sensing target and the position of the sensing entity #2 is R2. When R2 is less than or equal to Rₜ₂, the SDPF determines that the sensing entity #1 may stop executing the sensing service #A.

It should be understood that the SSCF may send the configuration information #1 to the SDPF, and determine Rₜ₂ based on the configuration information #1.

In a possible implementation, the sensing entity #2 starts to execute the sensing service #A, and sends a sensing response message to the SDPF. The SDPF determines that the sensing entity #1 may stop executing the sensing service #A.

Either step S660a or step S660b may be performed.

When determining that the sensing entity #1 may stop executing the sensing service #A, the sensing entity #2 or the SDPF may indicate the sensing entity #1 to stop executing the sensing service #A.

S670a: The sensing entity #2 sends request information #2 to the sensing entity #1.

The request information #2 indicates the sensing entity #1 to stop executing the sensing service #A.

In a possible implementation, the sensing entity #2 may send a sensing response message to the sensing entity #1, and the sensing entity #1 stops executing the sensing service #A based on the response message.

The request information #2 may include the identifier of the sensing service #A.

S670b: The SDPF sends the request information #2 to the sensing entity #1.

The request information #2 indicates the sensing entity #1 to stop executing the sensing service #A.

The request information #2 may include the identifier of the sensing service #A.

Either step S670a or step S670b may be performed.

S680: The sensing entity #1 stops executing the sensing service #A based on the request information #2.

Before the sensing entity #1 receives the request information #2, the sensing entity #1 and the sensing entity #2 may simultaneously execute the sensing service #A. When the sensing target has entered the sensing range in which the sensing entity #2 can ensure service continuity of the sensing service, the sensing entity #1 stops executing the sensing service #A.

Based on the foregoing technical solution, the sensing entity #1 may determine, based on the configured sensing range for ensuring the continuity of the sensing service, another sensing entity to continue to execute the sensing service. When the sensing target enters a sensing range in which the another sensing entity can ensure the service continuity of the sensing service, the sensing entity #1 stops sensing, thereby ensuring that valid sensing data of the sensing service is continuously uploaded, meeting a requirement of the sensing service, and improving a sensing capability.

The following describes an example solution in which the SDPF determines another sensing entity to execute the first sensing service.

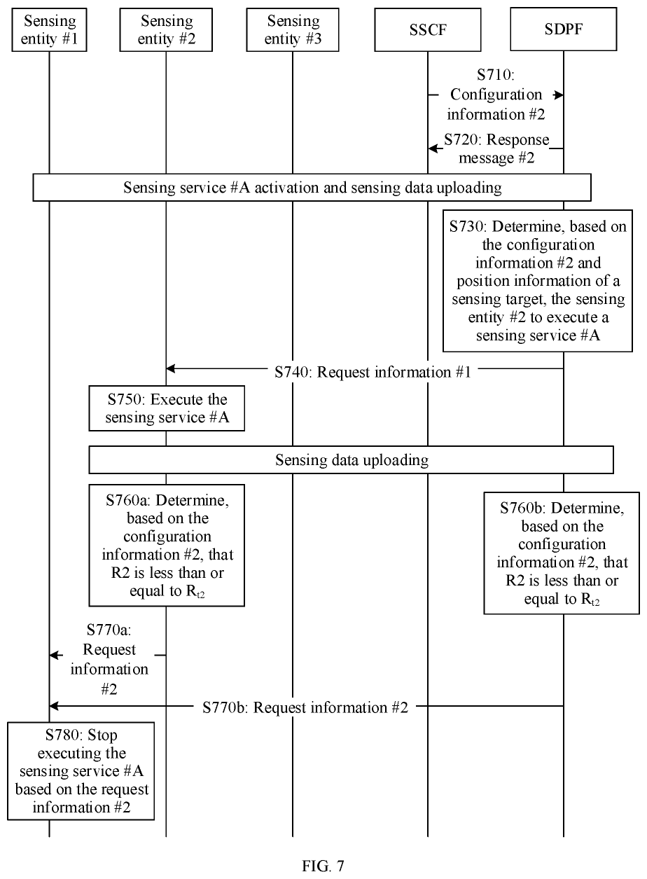

FIG. 7 is a diagram of a communication method for sensing applicable to an embodiment of this application.

In this embodiment, a sensing entity includes a sensing entity #1, a sensing entity #2, and a sensing entity #3. An example in which a first network device is an SDPF, a second network device is an SSCF, and a first sensing service is a sensing service #A is used.

A method 700 may specifically include the following steps.

S710: The SSCF sends configuration information #2 to the SDPF.

The configuration information #2 may include indication information of the sensing service #A, indication information of the sensing entity #1, indication information of the sensing entity #2, indication information of the sensing entity #3, and sensing ranges (Rₜ₁ of the sensing entity #1, Rₜ₂ of the sensing entity #2, and Rₜ₃ of the sensing entity #3) of all sensing entities for a service requirement of the sensing service #A.

The indication information of the sensing service #A may be, for example, an identifier or a name of the sensing service #A. The indication information of the sensing entity #1 may be, for example, an identifier or a name of the sensing entity #1. The indication information of the sensing entity #2 may be, for example, an identifier or a name of the sensing entity #2.

In the following, to avoid repetition, an example in which the indication information of the sensing service #A is the identifier of the sensing service #A, the indication information of the sensing entity #1 is the identifier of the sensing entity #1, and the indication information of the sensing entity #2 is the identifier of the sensing entity #2 is used.

In an optional understanding, the SSCF sends, to the SDPF, sensing ranges of the sensing entity #1 and an adjacent sensing entity for the service requirement of the sensing service #A.

The sensing ranges of the sensing entity #1 and the adjacent sensing entity for the service requirement of the sensing service #A are sent to the SDPF by using the configuration information #2. In other words, the configuration information #2 may include the service identifier of the sensing service #A, the identifier of the sensing entity #1, the identifier of the sensing entity #2, and the identifier of the sensing entity #3 (Rₜ₁, Rₜ₂, Rₜ₃).

Rₜ₁ is an example of a first threshold, and indicates the sensing range of the sensing entity #1 for the service requirement of the sensing service #A. Rₜ₂ is an example of a second threshold, and indicates the sensing range of the sensing entity #2 for the service requirement of the sensing service #A. Rₜ₃ is an example of a third threshold, and indicates the sensing range of the sensing entity #3 for the service requirement of the sensing service #A.

It should be understood that, Rₜ₁, Rₜ₂, and Rₜ₃ are determined by the SSCF based on the service requirement of the sensing service #A. To be specific, after a sensing target moves out of the sensing range that corresponds to a current sensing entity for the service requirement of the sensing service, service continuity may be affected. In this case, sensing data of the current sensing entity may be invalid. In this case, another sensing entity may be determined to continue to execute the sensing service #A.

It may be understood that a maximum sensing range of the sensing entity is greater than the sensing range for ensuring the continuity of the sensing service, or the sensing range for the service requirement of the sensing service. The sensing target moves out of the sensing range for ensuring the continuity of the sensing service, but is still within the maximum sensing range of the sensing entity. In this case, the continuity of the sensing service may not be ensured due to a distance problem of the sensing target, and the sensing data of the sensing entity may also be invalid.

The configuration information #2 may further include a determining mode #2, and the determining mode #2 indicates the SDPF to determine another sensing entity to execute the sensing service #A.

The configuration information #2 may further include a maximum effective sensing distance Rₘₐₓ₁ of the sensing entity #1, a maximum effective sensing distance Rₘₐₓ₂ of the sensing entity #2, and a maximum effective sensing distance Rₘₐₓ₃ of the sensing entity #3.

The configuration information #2 may further include position information of the sensing entity #1, the sensing entity #2, and the sensing entity #3.

S720: The SDPF sends a response message #2 to the SSCF.

After receiving the configuration information #2, the SDPF may send the response message #2 to the SSCF.

S730: The SDPF determines, based on the configuration information #2 and position information of the sensing target, the sensing entity #2 to execute the sensing service #A.

The SSCF may activate the sensing entity #1 to execute the sensing service #A. For example, the SSCF may determine, based on the service requirement of the sensing service #A and current position information of the sensing target, that the sensing entity #1 may be activated to execute the sensing service #A.

The sensing entity #1 executes the sensing service #A, and sends sensing data to the SDPF.

The SDPF may determine, based on the sensing data, that a distance between a current position of the sensing target and a position of the sensing entity #1 is R1. When R1 is greater than or equal to Rₜ₁, the SDPF determines another sensing entity to execute the sensing service #A.

It may be understood that, when R1 is greater than or equal to Rₜ₁, the SDPF may determine that the sensing target has moved out of or is about to move out of the sensing range for ensuring the service continuity of the sensing service. In this case, another sensing entity may be determined to execute the sensing service #A, to ensure the continuity of the sensing service #A.

For example, the SDPF may determine, based on an algorithm, the sensing entity #2 to execute the sensing service #A.

Alternatively, the SDPF may determine the sensing entity #2 in another manner. This is not limited in embodiments of this application.

S740: The SDPF sends the request information #1 to the sensing entity #2.

The request information #1 is used to request the sensing entity #2 to execute the sensing service #A.

The request information #1 may include the service identifier of the sensing service #A, the identifier of the sensing entity #1, the identifier of the sensing entity #2, sensing information, and the like.

S750: The sensing entity #2 executes the sensing service #A.

The sensing entity #2 executes the sensing service #A based on the request information #1.

The sensing entity #2 uploads sensing data to the SDPF.

When executing the sensing service #A, the sensing entity #2 may determine that the sensing target has entered the sensing range for ensuring the service continuity of the sensing service, or the SDPF may determine, based on the sensing data, that the sensing target has entered the sensing range for ensuring the service continuity of the sensing service, to indicate the sensing entity #1 to stop sensing.

That the sensing entity #2 determines and indicates the sensing entity #1 to stop sensing may specifically include the following steps S760a and S770a. That the SDPF determines and indicates the sensing entity #1 to stop sensing may include the following steps S760b and S770b.

Specifically, the following steps S760a and S760b may be included.

S760a: The sensing entity #2 determines, based on the configuration information #1, that R2 is less than Rₜ₂.

The sensing entity #2 determines, based on the sensing data, that a distance between the current position of the sensing target and a position of the sensing entity #2 is R2. When R2 is less than or equal to Rₜ₂, the sensing entity #2 determines that the sensing entity #1 may stop executing the sensing service #A.

It may be understood that, when R2 is less than or equal to Rₜ₂, the sensing entity #2 may determine that the sensing target has entered the sensing range for ensuring the service continuity of the sensing service. In this case, another sensing entity may be determined to stop executing the sensing service #A, and the sensing entity #2 may ensure the continuity of the sensing service #A.

S760b: The SDPF determines, based on the configuration information #1, that R2 is less than Rₜ₂.

The SDPF determines, based on the sensing data of the sensing entity #2, that the distance between the current position of the sensing target and the position of the sensing entity #2 is R2. When R2 is less than or equal to Rₜ₂, the SDPF determines that the sensing entity #1 may stop executing the sensing service #A.

It should be understood that the SSCF may send the configuration information #2 to the SDPF, and determine Rₜ₂ based on the configuration information #2.

In a possible implementation, the sensing entity #2 starts to execute the sensing service #A, and sends a sensing response message to the SDPF. The SDPF determines that the sensing entity #1 may stop executing the sensing service #A.

Either step S760a or step S760b may be performed.

When determining that the sensing entity #1 may stop executing the sensing service #A, the sensing entity #2 or the SDPF may indicate the sensing entity #1 to stop executing the sensing service #A.

S770a: The sensing entity #2 sends request information #2 to the sensing entity #1.

The request information #2 indicates the sensing entity #1 to stop executing the sensing service #A.

In a possible implementation, the sensing entity #2 may send a sensing response message to the sensing entity #1, and the sensing entity #1 stops executing the sensing service #A based on the response message.

The request information #2 may include the identifier of the sensing service #A.

S770b: The SDPF sends the request information #2 to the sensing entity #1.

The request information #2 indicates the sensing entity #1 to stop executing the sensing service #A.

The request information #2 may include the identifier of the sensing service #A.

Either step S670a or step S670b may be performed.

S780: The sensing entity #1 stops executing the sensing service #1 based on the request information #2.

Before the sensing entity #1 receives the request information #2, the sensing entity #1 and the sensing entity #2 may simultaneously execute the sensing service #A. When the sensing target has entered the sensing range in which the sensing entity #2 can ensure service continuity of the sensing service, the sensing entity #1 stops executing the sensing service #A.

Based on the foregoing technical solution, the SDPF, as a data processing network element, may determine, based on the configured sensing range for ensuring the continuity of the sensing service and the sensing data uploaded by the sensing entity, another sensing entity to continue to execute the sensing service. When the sensing target enters a sensing range in which the another sensing entity can ensure the service continuity of the sensing service, the sensing entity #1 stops sensing, thereby ensuring that valid sensing data of the sensing service is continuously uploaded, meeting a requirement of the sensing service, and improving a sensing capability.

The following describes an example solution in which the SSCF determines another sensing entity to execute the first sensing service.

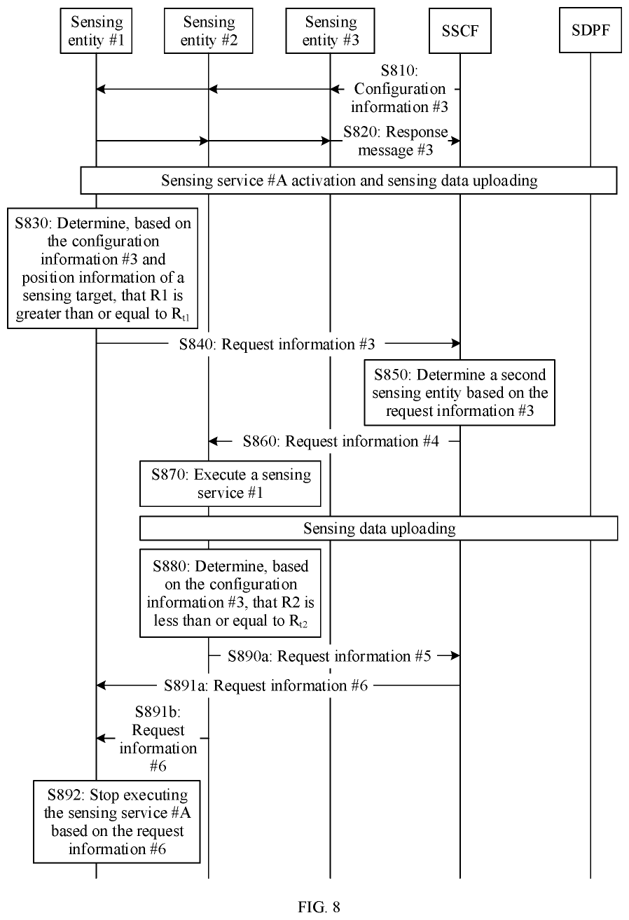

FIG. 8 is a diagram of a communication method for sensing applicable to an embodiment of this application.

In this embodiment, a sensing entity includes a sensing entity #1, a sensing entity #2, and a sensing entity #3. An example in which a first network device is an SDPF, a second network device is an SSCF, and a first sensing service is a sensing service #A is used.

A method 800 may specifically include the following steps.

S810: The SSCF sends configuration information #3 to the sensing entity #1, the sensing entity #2, and the sensing entity #3.

The configuration information #3 may include indication information of the sensing service #A, and for different sensing entities, may further include respective sensing ranges of the sensing entities for a service requirement of the sensing service #A.

The indication information of the sensing service #A may be, for example, an identifier or a name of the sensing service #A.

In the following, to avoid repetition, an example in which the indication information of the sensing service #A is the identifier of the sensing service #A is used.

In an optional understanding, the SSCF separately sends, to different sensing entities, respective sensing ranges for the service requirement of the sensing service #A.

The sensing ranges for the service requirement of the sensing service #A are respectively sent to different sensing entities by using the configuration information #3. To be specific, the configuration information #3 sent by the SSCF to the sensing entity #1 may include the service identifier of the sensing service #A and Rₜ₁. The configuration information #3 sent by the SSCF to the sensing entity #2 may include the service identifier of the sensing service #A and Rₜ₂. The configuration information #3 sent by the SSCF to the sensing entity #3 may include the service identifier of the sensing service #A and Rₜ₃.

Rₜ₁ is an example of a first threshold, and indicates the sensing range of the sensing entity #1 for the service requirement of the sensing service #A. Rₜ₂ is an example of a second threshold, and indicates the sensing range of the sensing entity #2 for the service requirement of the sensing service #A. Rₜ₃ is an example of a third threshold, and indicates the sensing range of the sensing entity #3 for the service requirement of the sensing service #A.

It should be understood that, Rₜ₁, Rₜ₂, and Rₜ₃ are determined by the SSCF based on the service requirement of the sensing service #A. To be specific, after a sensing target moves out of the sensing range that corresponds to a current sensing entity for the service requirement of the sensing service #A, service continuity may be affected, and sensing data of the current sensing entity may be invalid in this case. In this case, another sensing entity may be determined to continue to execute the sensing service #A.

It may be understood that a maximum sensing range of the sensing entity is greater than the sensing range for ensuring the continuity of the sensing service. The sensing target moves out of the sensing range for ensuring the continuity of the sensing service, but is still within the maximum sensing range of the sensing entity. In this case, the continuity of the sensing service may not be ensured due to a distance problem of the sensing target, and the sensing data of the sensing entity may also be invalid.

The configuration information #3 may further include a determining mode #3, and the determining mode #3 indicates the SSCF to determine another sensing entity to execute the sensing service #A.

S820: The sensing entity #1, the sensing entity #2, and the sensing entity #3 send a response message #3 to the SSCF.

After receiving the configuration information #3, the sensing entity #1, the sensing entity #2, and the sensing entity #3 may send the response message #3 to the SSCF.

S830: The sensing entity #1 determines, based on the configuration information #3 and position information of the sensing target, that R1 is greater than or equal to Rₜ₁.

The SSCF may activate the sensing entity #1 to execute the sensing service #A. For example, the SSCF may determine, based on the service requirement of the sensing service #A and current position information of the sensing target, that the sensing entity #1 may be activated to execute the sensing service #A.

The sensing entity #1 executes the sensing service #A, and sends sensing data to the SDPF.

The sensing entity #1 determines, based on the sensing data, that the distance R1 between the current position of the sensing target and a position of the sensing entity #1 is greater than or equal to Rₜ₁.

In an optional understanding, the sensing entity #1 may determine that the sensing target has moved out of or is about to move out, from the current position, of the sensing range for ensuring the service continuity of the sensing service. In this case, a control network element may be requested to determine another sensing entity to execute the sensing service #A, to ensure continuity of the sensing service #A.

S840: The sensing entity #1 sends request information #3 to the SSCF.

The sensing entity #1 sends the request information #3 to the SSCF based on R1 being greater than or equal to Rₜ₁, where the request information #3 is used to request the SSCF to determine another sensing entity to execute the sensing service #A.

The request information #3 may include the identifier of the sensing service #A, an identifier of the sensing entity #1, the position information of the sensing target, and the like.

S850: The SSCF determines a second sensing entity based on the request information #3.

For example, the SSCF may determine, based on an algorithm, the sensing entity #2 to execute the sensing service #A.

Alternatively, the SSCF may determine the sensing entity #2 in another manner. This is not limited in embodiments of this application.

It should be noted that the SSCF may obtain, in a registration phase, indication information, sensing capability information, and position information of the sensing entity #1 and an adjacent sensing entity.

The indication information of the sensing entity may be an identifier or a name of the sensing entity, or may be other information indicating the sensing entity. This is not limited in embodiments of this application.

For example, the SSCF may obtain maximum effective sensing distances and position information of the sensing entity #1, the sensing entity #2, and the sensing entity #3.

The SSCF may determine, based on the indication information, the sensing capability information, and the position information of the sensing entity #1 and the adjacent sensing entity, the sensing entity #2 to execute the sensing service #A.

S860: The SSCF sends request information #4 to the sensing entity #2.

The request information #4 is used to request the sensing entity #2 to execute the sensing service #A.

The request information #4 may include the service identifier of the sensing service #A, the identifier of the sensing entity #1, the identifier of the sensing entity #2, sensing information, and the like.

S870: The sensing entity #2 executes the sensing service #1.

The sensing entity #2 executes the sensing service #A based on the request information #4.

S880: The sensing entity #2 determines, based on the configuration information #3, that R2 is less than or equal to Rₜ₂.

The sensing entity #2 uploads sensing data to the SDPF.

The sensing entity #2 determines, based on the sensing data, that a distance between the current position of the sensing target and a position of the sensing entity #2 is R2. When R2 is less than or equal to Rₜ₂, the sensing entity #2 determines that the sensing entity #1 may stop executing the sensing service #A.

When executing the sensing service #A, the sensing entity #2 may determine that the sensing target has entered the sensing range for ensuring the service continuity of the sensing service, to indicate the sensing entity #1 to stop sensing, or indicate the sensing entity #1 to stop sensing through the SSCF.

Indicating the sensing entity #1 to stop sensing through the SSCF specifically include the following steps S890a and S891a. That the sensing entity #2 indicates the sensing entity #1 to stop sensing may specifically include the following steps S891b.

S890a: The sensing entity #2 sends request information #5 to the SSCF.

The request information #5 indicates the sensing entity #1 to stop executing the sensing service #A.

In a possible implementation, the sensing entity #2 may send a sensing response message to the SSCF, and the SSCF indicates, based on the response message, the sensing entity #1 to stop executing the sensing service #A.

The request information #5 may include the identifier of the sensing service #A.

S891a: The SSCF sends request information #6 to the sensing entity #1.

The request information #6 indicates the sensing entity #1 to stop executing the sensing service #A.

In a possible implementation, the SSCF may send a sensing response message to the sensing entity #1, and the sensing entity #1 stops executing the sensing service #A based on the response message.

The request information #6 may include the identifier of the sensing service #A.

S891b: The sensing entity #2 sends request information #6 to the sensing entity #1.

The sensing entity #2 may determine, based on a result that R2 is less than or equal to Rₜ₂, that the sensing target has entered the sensing range of the sensing entity #2 for ensuring the service continuity of the sensing service, and indicates the sensing entity #1 to stop sensing.

In a possible implementation, the sensing entity #2 may send a sensing response message to the sensing entity #1, and the sensing entity #1 stops executing the sensing service #A based on the response message.

S892: The sensing entity #1 stops executing the sensing service #1 based on the request information #6.

Before the sensing entity #1 receives the request information #2, the sensing entity #1 and the sensing entity #2 may simultaneously execute the sensing service #A. When the sensing target has entered the sensing range in which the sensing entity #2 can ensure service continuity of the sensing service, the sensing entity #1 stops executing the sensing service #A.

Based on the foregoing technical solution, the sensing entity #1 may determine, based on the configured sensing range for ensuring the continuity of the sensing service, to request the SSCF to determine another sensing entity to continue to execute the sensing service. When the sensing target enters a sensing range in which the another sensing entity can ensure the service continuity of the sensing service, the sensing entity #1 stops sensing, thereby ensuring that valid sensing data of the sensing service is continuously uploaded, meeting a requirement of the sensing service, and improving a sensing capability.

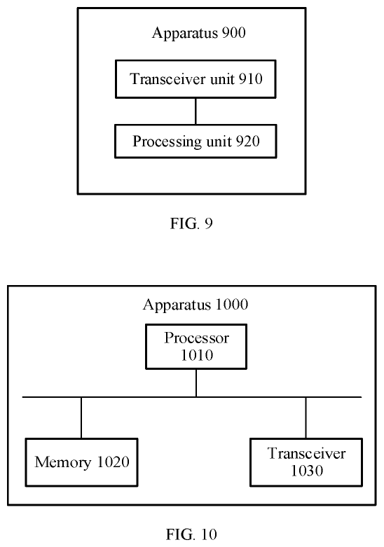

With reference to FIG. 5 to FIG. 8, the foregoing describes in detail the method provided in embodiments of this application. The following describes in detail apparatuses provided in embodiments of this application with reference to FIG. 9 and FIG. 10. It should be understood that descriptions of the apparatus embodiments are corresponding to the descriptions of the method embodiments. Therefore, details not fully set forth herein may be referred to the foregoing method embodiments and will not be repeated for brevity.

The apparatus is configured to implement the foregoing embodiments and related implementations. Details that already been provided are not described again. As used below, the term “module” may be a combination of software and/or hardware that can implement a predetermined function. Although the apparatus described in the following embodiments is preferably implemented by using software, an implementation of hardware or a combination of software and hardware is also possible and can be conceived.

FIG. 9 is a diagram of a structure of a communication apparatus according to an embodiment of this application.

The apparatus 900 includes a transceiver unit 910 and a processing unit 920. The transceiver unit 910 may be configured to implement a corresponding communication function. The processing unit 920 may be configured to perform data processing.

Optionally, the transceiver unit 910 may also be referred to as a communication interface or a communication unit, and includes a sending unit and/or a receiving unit. The transceiver unit 910 may be a transceiver (including a transmitter and/or a receiver), an input/output interface (including an input interface and/or an output interface), a pin, a circuit, or the like. The transceiver unit 910 may be configured to perform a sending step and/or a receiving step in the foregoing method embodiments.

Optionally, the processing unit 920 may be a processor (may include one or more processors), a processing circuit having a processor function, or the like, and may be configured to perform a step other than sending and receiving in the foregoing method embodiments.

Optionally, the apparatus 900 further includes a storage unit. The storage unit may be a memory, an internal storage unit (for example, a register or a cache), an external storage unit (for example, a read-only memory or a random access memory), or the like. The storage unit is configured to store instructions. The processing unit 920 executes the instructions stored in the storage unit, so that the communication apparatus performs the foregoing method.

In a design, the apparatus 900 may be configured to perform an action performed by the first sensing entity or the first network device in the foregoing method embodiments. For example, the apparatus 900 may be configured to perform an action performed by the first sensing entity or the first network device in the foregoing method 500. In this case, the apparatus 900 may be a component of the first sensing entity or the first network device. The transceiver unit 910 is configured to perform a receiving/sending-related operation on the first sensing entity or the first network device side in the foregoing method embodiments. The processing unit 920 is configured to perform a processing-related operation of the first sensing entity or the first network device in the foregoing method embodiments.

For example, the transceiver unit 910 is configured to receive first configuration information, where the first configuration information includes a first threshold, the first threshold indicates a sensing range of a first sensing entity for a service requirement of a first sensing service, the first threshold is determined based on the service requirement of the first sensing service, and the first sensing service is implemented based on sensing on a first sensing target by the first sensing entity. The processing unit 920 is configured to determine, based on the first configuration information and position information of the first sensing target, another sensing entity to execute the first sensing service.

It should be understood that the transceiver unit 910 may further perform another operation performed by the first sensing entity or the first network device in any one of the foregoing methods 500. Details are not described herein again.

In a design, the apparatus 900 may be configured to perform an action performed by the second network device in the method embodiments. For example, the apparatus 900 may be configured to perform an action performed by the second network device in the method 500. In this case, the apparatus 900 may be a component of the second network device. The transceiver unit 910 is configured to perform a receiving/sending-related operation on a second network device side in the method embodiments. The processing unit 920 is configured to perform a processing-related operation of the second network device in the method embodiments.

For example, the transceiver unit 910 is configured to receive third request information, where the third request information is determined by the first sensing entity based on the first configuration information, the first configuration information includes the first threshold, the first threshold indicates the sensing range of the first sensing entity for the first sensing service, the first threshold is determined based on the service requirement of the first sensing service, and the first sensing service is implemented based on sensing on the first sensing target by the first sensing entity. The processing unit 920 is configured to determine, based on the third request information, the second sensing entity to execute the first sensing service.

It should be understood that the transceiver unit 910 and the processing unit 920 may further perform another operation performed by the second network device in the foregoing method 500. Details are not described herein again.

It should be further understood that the apparatus 900 herein is embodied in a form of functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 900 may be specifically the network device in the foregoing embodiments, and may be configured to perform procedures and/or steps corresponding to the network device in the method embodiments. To avoid repetition, details are not described herein again.

The apparatus 900 in the foregoing solutions has a function of implementing a corresponding step performed by the device in the foregoing methods, or the apparatus 900 in the foregoing solutions has a function of implementing a corresponding step performed by the access network device in the foregoing methods. The function may be implemented by hardware, or may be implemented by executing corresponding software by hardware. The hardware or software includes one or more modules corresponding to the foregoing function. For example, a transceiver unit may be replaced with a transceiver (for example, a sending unit in the transceiver unit may be replaced with a transmitter, and a receiving unit in the transceiver unit may be replaced with a receiver), and another unit like a processing unit may be replaced with a processor, to separately perform sending and receiving operations and a related processing operation in the method embodiments.

In addition, the transceiver unit 910 may alternatively be a transceiver circuit (for example, may include a receiving circuit and a sending circuit), and the processing unit may be a processing circuit.

It should be noted that the apparatus in FIG. 9 may be the network element or the device in the foregoing embodiments, or may be a chip or a chip system, for example, a system on chip (SoC). The transceiver unit may be an input/output circuit or a communication interface. The processing unit is a processor, a microprocessor, or an integrated circuit integrated on the chip. This is not limited herein.

FIG. 10 is a diagram of a communication architecture according to an embodiment of this application. The communication apparatus 1000 shown in FIG. 10 includes one or more of a processor 1010, and optionally, one or more of a memory 1020 or a transceiver 1030. The processor 1010 is coupled to the memory 1020, and is configured to execute instructions stored in the memory 1020, to control the transceiver 1030 to send a signal and/or receive a signal.

It should be understood that the processor 1010 and the memory 1020 may be combined into one processing apparatus. The processor 1010 is configured to execute program code stored in the memory 1020, to implement the foregoing functions. During specific implementation, the memory 1020 may alternatively be integrated into the processor 1010, or may be independent of the processor 1010. It should be understood that the processor 1010 may alternatively correspond to each processing unit in the foregoing communication apparatus, and the transceiver 1030 may correspond to each receiving unit and sending unit in the foregoing communication apparatus.

It should be further understood that the transceiver 1030 may include a receiver (which is also referred to as a receiver machine) and a transmitter (which is also referred to as a transmitter machine). The transceiver may further include an antenna, and a quantity of antennas may be one or more. The transceiver may alternatively be a communication interface or an interface circuit.

Specifically, the communication apparatus 1000 may correspond to the first sensing entity or the first network device in the method 500 according to embodiments of this application. The communication apparatus 1000 may perform the steps performed by the first sensing entity or the first network device in the method 500. The communication apparatus 1000 may correspond to the second network device in the method 500 according to embodiments of this application. The communication apparatus 1000 may perform the steps performed by the second network device in the method 500. It should be understood that a specific process of the foregoing corresponding steps is described in detail in the foregoing method embodiments. For brevity, details are not described herein.

When the communication apparatus 1000 is a chip, the chip includes an interface unit and a processing unit. The interface unit may be an input/output circuit or a communication interface. The processing unit may be a processor, a microprocessor, or an integrated circuit integrated on the chip.

In an implementation process, steps in the foregoing methods can be implemented by using a hardware integrated logical circuit in the processor, or by using instructions in a form of software. The steps of the method disclosed with reference to embodiments of this application may be directly performed and completed by a hardware processor, or may be performed and completed by using a combination of hardware in the processor and a software module. A software module may be located in a mature storage medium in the art, like a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor. To avoid repetition, details are not described herein again.

It should be noted that, the processor in embodiments of this application may be an integrated circuit chip, and has a signal processing capability. In an implementation process, steps in the foregoing method embodiments can be implemented by using a hardware integrated logical circuit in the processor, or by using instructions in a form of software. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, the steps, and logical block diagrams that are disclosed in embodiments of this application. The general-purpose processor may be a microprocessor, or the processor may be any conventional processor or the like. The steps of the method disclosed with reference to embodiments of this application may be directly performed and completed by a hardware decoding processor, or may be performed and completed by using a combination of hardware in the decoding processor and a software module. A software module may be located in a mature storage medium in the art, like a random access memory, a flash memory, a read-only memory, a programmable read-only memory, an electrically erasable programmable memory, or a register. The storage medium is located in the memory, and a processor reads information in the memory and completes the steps in the foregoing methods in combination with hardware of the processor.

This application further provides a computer-readable medium storing a computer program. When the computer program is executed by a computer, functions of any one of the foregoing method embodiments are implemented.

This application further provides a computer program product. When the computer program product is executed by a computer, functions of any one of the foregoing method embodiments are implemented.

All or some of the foregoing embodiments may be implemented by using software, hardware, firmware, or any combination thereof. When software is used to implement the embodiments, all or a part of the embodiments may be implemented in a form of computer program product. The computer program product includes one or more computer instructions. When the computer instructions are loaded and executed on a computer, the procedure or functions according to embodiments of this application are all or partially generated. The computer may be a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, like a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state drive (SSD)), or the like.

In embodiments of this application, the term “example”, “for example”, or the like is used to represent giving an example, an illustration, or a description. Any embodiment or design scheme described as an “example” in this application should not be explained as being more preferred or having more advantages than another embodiment or design scheme. Exactly, use of the word “for example” is intended to present a concept in a specific manner.

It should be understood that, an “embodiment” mentioned throughout this specification means that particular features, structures, or characteristics related to this embodiment are included in at least one embodiment of this application. Therefore, embodiments in the entire specification do not necessarily refer to a same embodiment. In addition, these particular features, structures, or characteristics may be combined in one or more embodiments by using any appropriate manner.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application. Names of all nodes and messages in this application are merely names set for ease of description in this application, and may be different in an actual network. It should not be understood that names of various nodes and messages are limited in this application. On the contrary, any name that has a function that is the same as or similar to that of the node or the message used in this application is considered as a method or an equivalent replacement in this application, and falls within the protection scope of this application.

It should be further understood that, in this application, “when” and “if” mean that UE or a base station performs corresponding processing in an objective situation, but do not constitute any limitation on time, do not require the UE or the base station to perform a determining action during implementation, and do not mean other limitations either.

In addition, the terms “system” and “network” may be used interchangeably in this specification. The term “and/or” in this specification describes only an association relationship for describing associated objects and indicates that three relationships may exist. For example, A and/or B may indicate the following three cases: Only A exists, both A and B exist, and only B exists.

The term “at least one of . . . ” in this specification indicates all or any combination of the listed items. For example, “at least one of A, B, and C” may indicate the following six cases: Only A exists, only B exists, only C exists, both A and B exist, both B and C exist, and A, B, and C all exist. In this specification, “at least one” indicates one or more, and “a plurality of” indicates two or more.

The terms “include”, “comprise”, “have”, and variants thereof all mean “include but are not limited to”, unless otherwise specifically emphasized in another manner.

It should be understood that, in various embodiments of this application, first, second, and various numbers are merely for differentiation for ease of description, and are not for limiting the scope of embodiments of this application. For example, different information is differentiated.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to descriptions of a corresponding process and beneficial effects in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When functions are implemented in the form of software functional unit and sold or used as an independent product, the functions may be stored in a computer-readable storage medium. Based on such an understanding, the technical solutions of this application essentially, or the part contributing to the conventional technologies, or some of the technical solutions may be implemented in a form of software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method for sensing, applied to a first sensing entity or a first network device, and comprising:
receiving first configuration information, wherein the first configuration information comprises a first threshold, the first threshold indicates a sensing range of the first sensing entity for a first sensing service, the first threshold is determined based on a service requirement of the first sensing service, and the first sensing service is implemented based on sensing on a first sensing target by the first sensing entity; and
determining, based on the first configuration information and position information of the first sensing target, another sensing entity to execute the first sensing service.

2. The method according to claim 1, wherein the determining, based on the first configuration information and the position information of the first sensing target, the another sensing entity to execute the first sensing service comprises:
determining a first distance, wherein the first distance is a distance between the first sensing target and the first sensing entity; and
when the first distance is greater than or equal to the first threshold, determining the another sensing entity to execute the first sensing service.

3. The method according to claim 1, wherein the method further comprises:
generating first request information based on the first configuration information, wherein the first request information is used to request a second sensing entity to execute the first sensing service; and
sending the first request information to the second sensing entity.

4. The method according to claim 3, wherein the first request information comprises indication information of the first sensing service, indication information of the first sensing entity, indication information of the second sensing entity, and sensing information.

5. The method according to claim 3, wherein when the method is applied to the first sensing entity, the first configuration information further comprises indication information of a sensing entity and a first determining mode, the indication information of the sensing entity comprises the indication information of the first sensing entity and indication information of a sensing entity adjacent to the first sensing entity, and the first determining mode indicates the first sensing entity to determine the second sensing entity.

6. The method according to claim 5, wherein the method further comprises:
receiving, by the first sensing entity, second request information from the second sensing entity or the first network device; and
stopping executing the first sensing service based on the second request information.

7. The method according to claim 3, wherein when the method is applied to the first network device, the first configuration information further comprises indication information of a sensing entity and a second determining mode, the indication information of the sensing entity comprises the indication information of the first sensing entity and indication information of a sensing entity adjacent to the first sensing entity, and the second determining mode indicates the first network device to determine the second sensing entity.

8. The method according to claim 7, wherein the method further comprises:
sending, by the first network device, second request information to the first sensing entity, wherein the second request information is used to request to stop executing the first sensing service.

9. The method according to claim 8, wherein the method further comprises:
determining, by the first network device or a second sensing device, a second distance, wherein the second distance is a distance between the first sensing target and the second sensing entity; and
when the second distance is less than or equal to a second threshold, sending the second request information to the first sensing entity.

10. The method according to claim 1, wherein the method further comprises:
generating third request information based on the first configuration information, wherein the third request information is used to request a second network device to determine a second sensing entity; and
sending the third request information to the second network device.

11. A communication method for sensing, applied to a second network device, and comprising:
receiving third request information, wherein the third request information is determined by a first sensing entity based on first configuration information, the first configuration information comprises a first threshold, the first threshold indicates a sensing range of the first sensing entity for a first sensing service, the first threshold is determined based on a service requirement of the first sensing service, and the first sensing service is implemented based on sensing on a first sensing target by the first sensing entity; and
determining, based on the third request information, a second sensing entity to execute the first sensing service.

12. The method according to claim 11, wherein the third request information comprises indication information of the first sensing service, indication information of the first sensing entity, and sensing information.

13. The method according to claim 11, wherein the method further comprises:
sending fourth request information to the second sensing entity, wherein the fourth request information comprises the indication information of the first sensing service, the indication information of the first sensing entity, indication information of the second sensing entity, and sensing information.

14. The method according to claim 11, wherein before receiving the third request information, the method further comprises:
sending the first configuration information to the first sensing entity and/or a first network device.

15. The method according to claim 14, wherein the first configuration information further comprises the indication information of the first sensing service and a third determining mode, and the third determining mode indicates the second network device to determine the second sensing entity.

16. The method according to claim 15, wherein the method further comprises:
receiving fifth request information sent from the second sensing entity; and
sending sixth request information to the first sensing entity based on the fifth request information, wherein the fifth request information is used to request the first sensing entity to stop executing the first sensing service.

17. A communication apparatus, comprising at least one processor, wherein the at least one processor is configured to execute a computer program or instructions, to enable the communication apparatus to perform operations comprising:
receiving first configuration information, wherein the first configuration information comprises a first threshold, the first threshold indicates a sensing range of a first sensing entity for a first sensing service, the first threshold is determined based on a service requirement of the first sensing service, and the first sensing service is implemented based on sensing on a first sensing target by the first sensing entity; and
determining, based on the first configuration information and position information of the first sensing target, another sensing entity to execute the first sensing service.

18. The communication apparatus according to claim 17, wherein the determining, based on the first configuration information and the position information of the first sensing target, the another sensing entity to execute the first sensing service comprises:
determining a first distance, wherein the first distance is a distance between the first sensing target and the first sensing entity; and
when the first distance is greater than or equal to the first threshold, determining the another sensing entity to execute the first sensing service.

19. The communication apparatus according to claim 17, wherein the operations further comprises:
generating first request information based on the first configuration information, wherein the first request information is used to request a second sensing entity to execute the first sensing service; and
sending the first request information to the second sensing entity.

20. The communication apparatus according to claim 19, wherein the first request information comprises indication information of the first sensing service, indication information of the first sensing entity, indication information of the second sensing entity, and sensing information.

21. The communication apparatus according to claim 19, wherein when the apparatus is the first sensing entity, the first configuration information further comprises indication information of a sensing entity and a first determining mode, the indication information of the sensing entity comprises the indication information of the first sensing entity and indication information of a sensing entity adjacent to the first sensing entity, and the first determining mode indicates the first sensing entity to determine the second sensing entity.

22. The communication apparatus according to claim 19, wherein when the apparatus is a first network device, the first configuration information further comprises indication information of a sensing entity and a second determining mode, the indication information of the sensing entity comprises the indication information of the first sensing entity and indication information of a sensing entity adjacent to the first sensing entity, and the second determining mode indicates the first network device to determine the second sensing entity.

23. A communication apparatus, comprising at least one processor, wherein the at least one processor is configured to execute a computer program or instructions, to enable the communication apparatus to perform operations comprising:
receiving third request information, wherein the third request information is determined by a first sensing entity based on first configuration information, the first configuration information comprises a first threshold, the first threshold indicates a sensing range of the first sensing entity for a first sensing service, the first threshold is determined based on a service requirement of the first sensing service, and the first sensing service is implemented based on sensing on a first sensing target by the first sensing entity; and
determining, based on the third request information, a second sensing entity to execute the first sensing service.

24. The communication apparatus according to claim 23, wherein the third request information comprises indication information of the first sensing service, indication information of the first sensing entity, and sensing information.

25. The communication apparatus according to claim 23, wherein the operations further comprises:
sending fourth request information to the second sensing entity, wherein the fourth request information comprises the indication information of the first sensing service, the indication information of the first sensing entity, indication information of the second sensing entity, and sensing information.
